(19) United States
(12) Patent Application Publication
(10) Pub. No.: US 2011/0314805 A1
(43) Pub. Date: Dec. 29, 2011

(54) HEAT ENGINE WITH REGENERATOR AND TIMED GAS EXCHANGE

(76) Inventors: Joseph B. Seale, Gorham, ME (US); Gary Bergstrom, Chagrin Falls, OH (US)

(21) Appl. No.: 13/255,468

(22) PCT Filed: Mar. 12, 2010
(86) PCT No.: PCT/US2010/000758

§ 371 Date: Sep. 8, 2011

Related U.S. Application Data
(60) Provisional application No. 61/209,921, filed on Mar. 12, 2009.
(60) Provisional application No. 61/336,494, filed on Jan. 22, 2010.

(51) Int. Cl. F02G 1/05; F02G 1/053

(52) U.S. Cl. 60/522

(57) ABSTRACT

A Stirling-like system incorporating a heater, a displacer and a regenerator is intermittently coupled to an external system via valves, providing pneumatic power while ridding waste heat. The external system is commonly a Rankine cycle, sharing the working fluid of the Stirling-like system, and can be used for heat pumping, distillation and drying. The Stirling working fluid and the Rankine working fluid are the same material and are exchanged between the two systems. A dual Stirling-like system mates a heat engine with a heat pump, sharing the same pressure-containment, with the dual system intermittently coupled to external environments for convective exchange of heat and cold.

U.S. Provisional Patent Application No. 61/209,921, dated 12 Mar. 2009, “Stirling engine for direct mechanical compression,” by the inventor Seale named in the present application, is incorporated here by reference. The more recent U.S. Provisional Patent Application No. 61/336,494, dated 22 Jan. 2010, “Heat engine with regenerator and timed gas exchange” by inventors Seale and Bergstrom of the present application, is further incorporated by reference.

### FIELD OF THE INVENTION

The present invention relates to heat engines and heat pumps, incorporating aspects of Stirling engines and engines with timed opening of valves for gas exchange, particularly diesel engines. The invention is useful for heat pumping, refrigeration, and also for recycling of steam latent heat in superheated steam drying.

### BACKGROUND OF THE INVENTION

### Earlier Referenced Work

### Related Past Teachings

The following Specification will teach a core invention that can be viewed from several perspectives and can be configured in a variety of ways. The invention is a heat engine and a heat pump—two “separate” terms that refer to a device and a related process that can be employed in two directions: as a heat engine to convert a “downhill” hot-to-cool flow of heat into mechanical power; and as a heat pump to convert mechanical power into an “uphill” cool-to-hot or cold-to-warm flow of heat. The new invention will teach a merger of the heat engine and heat pump aspects into a unitary whole with the elimination of several costly and wasteful intermediate energy conversion steps. Important background for the present invention is found in the technology of Stirling engines and Stirling heat pump/refrigeration systems. Yet, most “Stirling” systems are closed thermodynamic cycles, where heat is conducted in and out through the walls of a hermetic containment. In some of the literature, a “Stirling engine” is a closed hermetic system by definition. Thus, parts of the present invention will be described as “Stirling-like” components or subsystems, sharing characteristics in common with Stirling engines but differing in three important respects:
1) Heat is exchanged by timed convection through valves rather than by conduction into and out of a hermetically closed system.
2) Adiabatic processes are substituted for parts of the “classic” Stirling cycle that called for continuous heat exchange between the internal system and external heat source and sink reservoirs.
3) Pneumatic pressure-times-volume energy exchanges are employed directly without the intervention of power pistons.

Pertinent to the present invention are examples of so-called Stirling-Diesel hybrids: systems that include valves and gas exchange with the external system or environment, operated in conjunction with reciprocating gas flow through a regenerator. Patton, in U.S. Pat. Nos. 7,219,630, 7,004,115 and earlier patents, teaches a system employing two pistons, one for intake and compression and the other for power delivery and exhaust functions, the first piston being coupled to the second through a regenerator. A parallel is seen where the core components of a Stirling engine are a displacer piston, a regenerator, and a power piston. Unlike external-combustion, hermetic Stirling engines, Patton's system resembles a Diesel engine, in that it breathes air and employs direct fuel injection into a gas that is sufficiently hot to cause immediate combustion without spark ignition. While diesel engines achieve the high air temperatures required for combustion through high compression ratios (typically 18-to-1) and the accompanying adiabatic heating, Patton's system uses low compression while most of the needed air pre-heating is accomplished with a regenerator. Timed internal combustion heat is produced, by fuel injection, in the “right place”—inside the combustion chamber, as opposed to externally—at the “right time”—when the power piston is being driven down, early in a power stroke. Heat that conducts inward through the walls of a conventional Stirling cylinder flows at all times. Idealized diagrams may show the path of incoming heat “blocked” by a moving regenerator or one or two moving pistons, but in such a situation, heat continues to flow into the sides of the regenerator, so there is little effective “timing” of the heat flow. Indeed, there is a tendency for a maximum heat flow rate to occur in a Stirling cylinder at the “wrong time”—when the cylinder temperature is at a minimum and the power piston is performing a compression stroke.

Patton provides an excellent review of the prior art, including many references giving relevant background to his own and the present inventors' teachings. In one such reference, U.S. Pat. No. 5,050,570, Thring teaches an “Open cycle internal combustion Stirling engine” incorporating two pistons with coaxial shafts and sharing a common cylinder, a typical Stirling engine configuration, also including a regenerator, but equipped with timed valves, fuel and spark ignition. In the more recent U.S. Pat. No. 5,499,605, Thring teaches a two-piston Stirling-hybrid configuration that anticipates the more advanced recent work of Patton. As will be seen, however, the present invention offers many useful, energy-saving functions not anticipated in Patton's work or the earlier work of Thring and others. In U.S. Pat. No. 5,632,255, “Regenerated engine with an improved heating stroke,” Ferrenberg teaches the use of a single moving element combining the functions of a regenerator and a displacer piston, henceforth described as a “regenerator piston” in the Specification below. Ferrenberg shows that a power piston and regenerator piston sharing a common cylinder can perform functions requiring two separate cylinders where the regenerator is a fixed component with through-flow of gas driven by a separate displacer piston. While Ferrenberg claims certain performance advantages to this unitary cylinder approach, more recent teachings of Patton (e.g., U.S. Pat. No. 7,219,630) show five valves used in conjunction with separate compressor and power pistons to accomplish a highly efficient hybrid Stirling-Diesel cycle. In U.S. Pat. No. 6,457,309, “Multifuel internal combustion Stirling engine,” Firey teaches pistons with coaxial shafts sharing a common cylinder, which he calls “displacer piston” and “compression piston.” Similar language is echoed in the Specification below, except that in place of “compression piston” the term “power piston” is used generically to describe both pistons that convert shaft power into compression power for refrigeration, and that convert pneumatic power to shaft power in heat engine. operation. Power pistons generally require sliding seals to fulfill pressure-bearing functions, though systems demonstrated, for example, by Global Cooling of Athens, Ohio, achieve power piston functionality with air bearings and no sliding seals. As will be seen in the following Specification, important functions traditionally requiring power pistons can be accomplished by purely pneumatic means, without the intervention of solid power piston components, nor of water pistons and the like (as taught for example in U.S. Pat. No. 4,676,066 by Tailer et. al., and in more recent teachings that reference Tailer.). Unlike a Stirling power piston, a Stirling displacer piston does not require tight sliding seals, but rather only a moderately close fit in the cylinder, since the low flow resistance of a typical Stirling regenerator results in little pressure difference across a displacer piston. Firey teaches a configuration wherein the displacer piston operates between the compression (or “power”) piston and the region where cylinder walls are exposed to hot combustion products. It is highly desirable for a compression or power piston to operate in a relatively cool cylinder, as this minimizes thermal expansion problems, reduces wear and results in a system that tolerates contamination and grit, including from combustion of dirty fuels (including coal in Firey's example.) This advantageous protection of heat-sensitive components by a displacer piston is carried into new and unanticipated contexts in the invention to be described below.

Stirling refrigeration systems are well known in the art, and have found particular application for cryogenic operation. In U.S. Pat. No. 4,996,841, Meijer et. al. teach a “Stirling cycle heat pump for heating and/or cooling systems” wherein a Stirling engine directly powers the rotary shaft that drives a Stirling heat pump. This extreme proximity of the fuel-powered prime mover to a heat pump might be contrasted with the Solar One and Solar Two projects by Stirling Energy Systems in California's Imperial Valley and Mojave Desert. There, solar-powered Stirling-electric generators are projected to produce over 1000 peak megawatts of electricity, whose greatest value to the utility system is to meet correlated extreme air conditioning load demands. While Meijer et. al. reduce the gap between Stirling producer and heat-pumping user from hundreds of kilometers to a fraction of a meter, it will be seen that the present invention brings these functions still closer together, in a manner that is compatible with solar power and that, solar- or fuel-driven, eliminates costly and wasteful intermediate energy conversions.

A rapidly emerging technology for drying of wet solids, ranging from grains to wood chips to sewage sludge, conducts the drying process in superheated steam, whose mass is increased as the drying wet materials give off steam. This continuously-produced steam is collected, compressed, and forced to condense at a temperature above the boiling point associated with the steam pressure inside the drying apparatus. The resulting steam condensation heat is transferred back into the drying apparatus, effectively recycling this heat energy to promote further drying. The Swedish company G.E.A. Barr-Rosin has successfully implemented this technique in multiple industrial applications, typically drying in a sealed apparatus at several atmospheres' pressure, while others have demonstrated similar techniques at lower pressures and associated boiling temperatures for use with heat-sensitive materials. These energy-saving processes are powered by a costly form of energy—electricity. As will be seen, the current invention extends naturally, in its applications, into the area of efficient drying, where superheated steam becomes the working fluid of an open-cycle Stirling-like system that interacts very directly with the drying materials. Recognizing that steam from drying materials will commonly be laden with grit, whether from laundry of sawdust being dried for fuel-wood pellet production, and recognizing that thorough filtration of grit from large volumes of steam entails costs and technical challenges, it will be appreciated that Meijer et. al. teach ways to make a Stirling engine that is tolerant of grit. The connection being suggested here was not recognized by Meijer et. al., however, nor by the growing industries that perform superheated steam drying. Effective energy-saving and cost-saving hybrid technologies of this sort are much needed, with a number of examples being taught below.

### Pertinent Heat Engine Principles

The invention to be taught below is best understood from a background of heat engine principles that have been applied, in separate contexts, to Stirling and Diesel engines. These engines are understood in a broad generalized context from the perspective of their associated idealized thermodynamic cycles. Though these cycles are amply described in the literature, the terminology and approaches differ from place to place. To establish background with a consistent approach and vocabulary the idealized Stirling and Diesel cycles will be reviewed briefly here, along with the Carnot cycle, which provides an instructive if impractical example of the best performance that can theoretically be achieved with a heat engine. The Specification will then proceed directly from these known thermal cycles to new cycles and variations, shown first as abstract graphs and then in exemplary practical embodiments of the invention.

The fundamental benchmark for heat engine efficiency was described by Carnot, in the form of equations and graphs relating to the idealized cycle bearing his name. The diagrams of FIGS. 1a and 1b are labeled “Prior Art” since they show concepts that have been known since the 1800s, though the particular illustrative forms, by an author of this patent, may be original and are chosen to demonstrate a conceptual symmetry that will be embodied in a practical invention, as taught in the following Specification.

In diagram 100 of FIG. 1a, the left side represents operation of a heat engine, converting a spontaneous, downhill (i.e. hot-to-cool) flow of heat to mechanical energy as work, while the right side represents symmetric operation as a heat pump, converting mechanical energy or work into a driven, uphill (i.e. cool-to-hot) flow of heat. In this mathematical idealization, approachable but not achievable in real-world devices, the energy transformations are reversible, as understood in thermodynamics. This implies that the total entropy of the system plus environment is unchanged throughout the process, whereas the non-ideal behavior of real systems inevitably causes an increase in entropy. Given an entropy “S”, an infinitesimal change in entropy of an object, “dS” is given by the well known equation:

dS=dQ/T

Here, dQ is an infinitesimal quantity of heat energy “Q” flowing into the object, and “T” is the absolute temperature, described in this Specification in Kelvin units, though Rankine units are also applicable. If an infinitesimal quantity “dQ” of heat flows from a first object at temperature T1 through a thermal flow resistance and into a second object at a lower temperature T2, then the change in entropy of the first object is dS1=−dQ/T1, a decrease since the object loses heat, while the change in entropy of the second object is dS2=dQ/T2, an increase of greater magnitude than “″dS1|” (read: “absolute value of dS1”) since denominator “T2” is smaller than denominator “T1”. Thus, the sum “dS1+dS2” is seen to increase whenever there is a temperature drop due to thermal flow resistance. If two objects are in thermal equilibrium at equal temperatures, then there will be no flow of heat. The observation that heat always flows “downhill” from higher to lower temperature, or does not flow at all for systems at equal temperatures, is re-stated in thermodynamics as a postulate, which along with very little additional information leads to the derivation of the Second Law (of Thermodynamics), namely that the entropy of a closed system always increases or remains the same. In that context, FIG. 1 and several idealized figures to follow represent thermodynamic behavior in the mathematical limit of approach to equilibrium, where heat flow rates approach zero along with the temperature differentials associated with heat flow and thermal resistance. These idealizations represent conceptually useful optimum limits for performance, while the engineering task to follow is to seek real systems whose efficiencies are a reasonably large fraction of the “Carnot Ideal” as now described in diagram 100 and in some figures to follow.

In 100, a large heat reservoir 102 is at a high temperature, for example 900 Kelvins, as labeled. Heat flows reversibly (i.e. with no temperature differential and no increase in entropy) via 106 into a heat engine 108, represented schematically by a vertically elongated rectangle. The dot patterns in his rectangle and the square blocks representing heat reservoirs indicate temperature by analogy to density of atoms or molecules of an ideal gas at a given constant pressure. Thus, as temperature approaches zero Kelvins, the gas particles come very close together and the dot density approaches black, while at high temperatures the gas density and dot density are low. The temperature-indicating dot density in 108 represents the operating temperature range from zero to the maximum temperature of the system, here 900 Kelvins by way of example. Heat engines require a heat source and a heat sink, and in this case the heat sink is represented by thermal reservoir 118, whose dot density is higher than in 102 to represent a lower temperature, 300 Kelvins in this example. Heat flows into 118 via path 116. The vertical extent of the curly brackets represent temperatures or temperature ranges: here the high temperature of 102 by bracket 104, the lower temperature of 118 by bracket 112, and the temperature difference between 102 and 118 by bracket 110. In heat engine 108, heat flows downhill across the temperature difference 110, which in this example is two-thirds as great at the absolute temperature indicated by bracket 104. In flowing two-thirds of the distance from the maximum system temperature toward absolute zero, two-thirds of the heat energy flowing through 106 is converted to a mechanical energy output 114, while the remaining one-third of the heat energy is not recoverable as mechanical energy and dumps into the heat sink 118 via 116. The generalization is easily seen. The maximum fraction of heat energy that can be converted to mechanical energy or work in a heat engine is the source-to-sink temperature differential (110) divided by the absolute temperature (104) of the source. This is expressed by the famous Carnot equation.

The fact that the process on the left of 100 is reversible implies both that there is no entropy increase and that the process can in fact be run in reverse, as the heat pump represented on the right of 100. Here, mechanical energy flows via 114 into heat engine 128, here operating as a heat pump, which uses its mechanical input energy to draw heat from a reservoir 122 at temperature 124 via path 126 into the engine. In this example, the output temperature is represented by 130, which is identical to 104, while the difference between 130 and 124 is the equivalent temperature difference 120. The quantity of output heat energy from 128 via 132 into thermal reservoir 134, at temperature 130, is seen to be the sum of heat energies entering the heat pump via paths 114 and 126, with the ratio of these two energy flows being represented by the ratio of height 120 to height 124. In the illustrated case, two-thirds of the output heat flow comes from mechanical energy flowing via 114, while the remaining one-third comes from heat energy drawn from 122 via 126. The ratio “two-thirds” is the same for the heat pump as it was as described above for the heat engine in this example, where the temperatures on the two sides match. It is not, however, necessary that the temperatures on the two sides match. Mechanical energy flowing via 114 is a “general purpose” type of energy whose use varies with context, as seen in FIG. 1b.

In diagram 150 of FIG. 1b, the system 152 on the left represents the system on the left of diagram 100, here shrunk graphically in the vertical dimension to illustrate a new situation. The rate of heat flow along path 156 from system 152 is considered to be the same as the flow along path 114 of diagram 100. On the right side, however, the maximum temperature 174 is much lower, 320 Kelvins in this example, while heat flows out of source 160 at temperature 164, 270 Kelvins in this example, via path 162 into heat pump 168. It is seen graphically and numerically that the source temperature and sink temperature are separated by a small fraction of the absolute temperature of the sink, and this implies a high Coefficient of Performance, or CoP, of the heat pump: the ratio of output heat flow via 170 to input mechanical energy flow via 156 is large. Furthermore, looking at the heat engine on the left side, where the heat source is much hotter than the heat sink, a large fraction of the source-derived heat energy flows out via 156 to the heat pump. Clearly, the conditions that yield high efficiency for a heat engine yield low efficiency for a heat pump, and vice versa.

As will be taught in the following Specification, it is possible to construct a highly efficient heat-powered heat pump employing a high-temperature heat source such as 102 (of 100) providing a small heat flow 106, so that a large heat flow is drawn across a relatively low temperature differential 158, drawing heat 162 from, and possibly refrigerating or air-conditioning, a heat source 160, while delivering “waste” or “useful” heat 170, and thereby heating a heat sink 172. The temperature 112 of heat sink 118 in 100 is shown as intermediate between the source and sink temperatures of system 150. In a system combining a heat engine and a heat pump to make a heat-powered heat pump, the heat sink 118 for the heat engine 100 becomes heat sink 172 of diagram 150. The high temperature heat sink 134 of diagram 100 becomes the lower temperature heat sink 172 of diagram 150, while the heat engine heat sink 118 of 100 is effectively combined with the heat pump heat sink to become the overall heat sink 172. By analogy, one can think of an electrical transformer with two terminals on the primary or power input side and two additional terminals on the secondary or power output side, a four-wire device. If one primary terminal is interconnected with one secondary terminal to a common ground, then one has a three-terminal device, or similarly, a three-wire autotransformer. The thermal system of diagram 150 abstractly describes a three-terminal thermal “step down autotransformer.” Employing analogous electrical terminology, one has a “high voltage” or high-temperature source for the heat engine component 152, not numbered separately but analogous to source 102 of diagram 100, a secondary “ground potential” or low-temperature source 160, and the “autotransformer” output terminal as heat sink 172, which receives both “waste” heat from system 152 and pumped heat from source 160. Where the intention is heating, whether for drying, space heating, distillation, or similar functions, the “waste” heat is not wasted but is part of the useful system output, combining with the pumped heat to achieve an effective system gain or Coefficient of Performance, “CoP”. In common usage, however, “CoP” refers to gain from electrical wattage input to thermal wattage output. In diagram 150, the system “CoP” is from high-temperature thermal power input to lower-temperature thermal power output.

Diagram 150 represents a theoretical possibility, not a practical implementation. As will be shown, there are means and methods for achieving usefully large fractions of the ideal heat-to-heat CoP performance or “Thermal Leverage” implied by these diagrams and the underlying Carnot equations for converting heat to work and work back to heat.

The Stirling Engine was first described by a Scotsman, the Reverend Dr. Robert Stirling, in an 1816 patent, and demonstrated in 1818, where it was used to pump water. The term “Stirling engine” has come to refer to a class of heat engines that incorporate an external heat source, a heat sink, and an internal gas cycle for producing mechanical energy. The term “Stirling heat pump” has come to refer to devices similar to Stirling engines but configured to operate in the opposite direction, employing mechanical energy to transport heat from a cooler region to a warmer region, the purpose being to refrigerate the cooler region, or heat the warmer region, or both. “Stirling cycle” refers to an idealized thermodynamic cycle that corresponds very roughly to the operation of a Stirling engine or Stirling heat pump. Similarly, “Diesel cycle” is a mathematical idealization of a lossless diesel engine, while “Carnot cycle” is a mathematical construct, representing a hypothetical engine that achieves an efficiency level that can be approached but never reached or exceeded with a real-world heat engine. These idealized cycles, known in the prior art, are reviewed briefly here, leading up to two new, non-conventional cycles that roughly characterize modes of operation of the present invention.

Graph 200 of FIG. 2a illustrates the idealized Carnot Pressure-Volume or P-V cycle, with pressure plotted on vertical axis 202 against volume on horizontal axis 204. The axis units are arbitrary and chosen only for qualitative illustration. The Carnot cycle starts at the temperature of a low temperature reservoir, following which the gas is compressed isothermally along path 206, with the gas losing heat to the low temperature reservoir with perfect conduction and infinitesimal temperature drop. At the end of this initial compression, the gas is thermally isolated and further compressed, adiabatically, along path 208, with the pressure rising more steeply as volume decreases due to a temperature rise to the level of the high temperature reservoir. The gas is then expanded in isothermal contact with the reservoir along path 210 and finally expanded adiabatically along path 212, returning to the starting point. It will be seen that for a real heat engine to approach this ideal, it would have to operate slowly to approach the required thermal equilibrium conditions. Energy is delivered during the expansion stroke as the integral of pressure times incremental volume, the “P dV” integral under the curve. However, most of the recovered energy must be put back in during compression. The relative proximity of the upper and lower curves indicates a low Mean Effective Pressure, or MEP, an indication that, in a real engine, implies a large fractional efficiency losses arising from relatively small frictional losses. In short, this “ideal” cycle is ideal only in a narrow mathematical sense.

Graph 250 of FIG. 2b illustrates an idealized Stirling P-V cycle, with pressure and volume axes 252 and 254. The much larger relative spacing between the upper and lower curves indicates a higher MEP and a more robust and practical system, at least in this one respect. As a reminder, light smooth curve 264 inside the idealized Stirling loop represents typical performance of a real Stirling engine. The idealized cycle starts with isothermal compression stroke 256, similar to the Carnot stroke 206. Along 258, the working fluid, a gas, is heated by passage through the temperature gradient of an ideal regenerator. This simple vertical curve hides an unreality, seemingly implying that all the gas is heated at once while the pressure rises smoothly. If gas were simply pushed through a regenerator, even a mathematically ideal regenerator, the pressure rise would tend to heat the gas on both sides of the regenerator, so that the ideal of perfect thermal equilibrium between the gas and the parts of the regenerator would be violated. To make this cycle ideal, it is necessary to maintain the gases on both sides of the regenerator in perfect thermal equilibrium with their respective hot and cold thermal reservoirs during the regenerator transition. This ideal is difficult to approach in practice, both for the heating stroke 258 and the later cooling stroke 262. Following the heating stroke there is an isothermal expansion along 260 at the temperature of the hot thermal reservoir, followed by the regenerator cooling stroke 262, returning the system to its original state.

Observe that adiabatic expansions and compressions can, and indeed must, proceed quickly in real machines (so that there is little time for heat transfer), whereas isothermal strokes must proceed relatively slowly to minimize losses. Thus we find a shortcoming of Stirling engines. Their dependence on equilibrium heat transfer in each of the four steps means, in practice, that it is difficult to construct a Stirling engine that exhibits high specific power, that is, high power-per-weight or high power-per-volume of the machine.

Graph 300 of FIG. 3a illustrates the P-V curve of an idealized Diesel cycle, with pressure axis 302 here indicating a possible range of real pressures in atmospheres while volume axis 304 indicates a compression ratio of 18-to-1 along adiabatic compression curve 306. Diesel combustion adds heat at constant pressure and increasing temperature along 308, followed by adiabatic expansion along 310. Remaining pressure above one atmosphere is dumped through the exhaust port along 312. The idealized closed thermodynamic cycle calls for a return to the original state of pressure and volume, while simply exhausting the excess pressure in still-hot gas along curve 312 would leave the cylinder with less than the original charge of gas mass, while the temperature would be elevated. In practice, an exhaust stroke replaces the combustion-heated gases with fresh cool gas, restoring the “original” state but with different gas on each stroke. Observe again the narrow curve with the relatively low Mean Effective Pressure or MEP. The high compression volume ratio and even higher pressure ratio imply very high peak forces, requiring robust heavy construction.

Graph 350 of FIG. 3b illustrates the Otto cycle, the model for a spark ignition engine, with pressure and volume axes 352 and 354 indicating realistic pressures in atmospheres and a realistic 8-to-1 compression ratio. Adiabatic compression 356 is followed by a constant-volume pressure spike 358 at ignition, followed by an adiabatic expansion 360. Segment 362, like Diesel segment 312, covers the actual processes of exhaust and intake of fresh air.

Graph 400 of FIG. 4 is the last of the “prior art” cycles, indicating qualitatively the operation of a Stirling-Diesel hybrid engine. Here the compression ratio is quite low, with a peak pressure under 3.5 atmospheres for a naturally aspirated engine. The cycle starts at one atmosphere (read on axis 402) and one unit volume (on axis 404) and proceeds through a small adiabatic compression along 406, followed by a constant volume heating stroke of the regenerator along 408. A true Stirling cycle would begin with an isothermal compression, while the real-world Stirling-Diesel, incorporating “Stirling-like” aspects, employs the much quicker adiabatic compression process. The constant pressure Diesel expansion, with smooth fuel injection and combustion, proceeds along 410, followed by an adiabatic expansion power stroke along 412. The regenerator recoups waste heat along cooling path 414. In practice, there is still waste heat left in the engine, and even an overexpansion may not have returned the pressure to one atmosphere. Arrows 416, back to the starting volume, and arrow 418, going all the way to zero volume, indicate a complete exhaust stroke, while arrow 420 represents the intake stroke, bringing in fresh air and restoring the system to its original state, but with a new charge of gas.

Pure Stirling engines as well as Stirling hybrid and Stirling-like engine designs revolve around a critical pair of components: a regenerator and either a displacer piston or a regenerator piston, the latter combining displacement and regeneration functions in a single moving part. This component pair will be called a Stirling Subsystem throughout the following Specification. A Stirling engine generally consists of this Stirling Subsystem plus a paired heat source and heat sink with a temperature differential to thermally power the system, plus a power piston and further mechanical energy conversion means, typically including a crankshaft, driven by the power piston. A Stirling heat pump is fundamentally similar to a Stirling engine except that it is configured to work in the opposite direction, using mechanical input energy from a power piston to move heat “uphill” against an opposing temperature gradient, from a heat source to a warmer heat sink. The objective may be to refrigerate the heat source or to warm the heat sink. As with a Stirling engine, a Stirling heat pump includes a Stirling Subsystem as described. More complicated Stirling systems may include multiple Stirling Subsystems, power pistons, heat sources and sinks, and interacting pistons may sometimes combine the functions of power piston and displacer piston in single moving parts.

The invention to be taught below employs a Stirling Subsystem as defined above, but differs from a Stirling engine or Stirling heat pump in other important respects. An understanding of existing Stirling engines is important for understanding the present invention.

Focusing first on the regenerator of a Stirling Subsystem, it consists of a porous, solid, heat-resistant medium that maintains a temperature gradient and transfers heat into and out of a gas-phase working fluid. Physically, a regenerator can be a canister of fine gravel, or a fused-together mesh of crossing wires, on a ceramic honeycomb of small gas-carrying channels, or a pressed-together bundle of capillary tubes. In an efficient utilization, gas going through the regenerator is always close to thermal equilibrium with the solid material. In normal operation, the regenerator has a “hot” end and a “cool” end, where “hot” and “cool” are relative terms and both could be above boiling or below freezing. The “axial” direction of the regenerator is taken to be the direction of the cool-to-hot temperature gradient, and also the direction of reversing gas flow. The hot-end absolute temperature may be more than double the cool-end absolute temperature, as a result of which the gas properties of density, viscosity, and molar specific heat may change considerably from one end to the other. Ignoring these nonlinear aspects and speaking in approximate terms regarding average gas properties, one can attribute an approximate time constant to the thermal equilibration of gas in the regenerator pores or channels with the solid surfaces in contact with the gas. The degree of thermal equilibration of gas with the solid regenerator material can then be expressed in terms of the equilibration time constant and the average transit time for gas traveling from one end to the other. Thus, for example, if the equilibration time constant is about one millisecond and the end-to-end transit time is about ten milliseconds, then the temperature of gas emerging from (say) the hot end will be cooler than the hot-end surface by roughly 10% of the total end-to-end temperature difference. In that case, one could say that the gas thermal equilibration is about 90% efficient. If the gas flow rate is then doubled, the equilibration efficiency will drop to about 80%, and if the flow rate is halved, then the equilibration efficiency will rise to about 95%. While these characterizations are approximate in ignoring nonlinear properties, they are nevertheless useful in describing regenerator performance.

### OBJECTS OF THE INVENTION

It is an object of the present invention to use a Stirling-like system, employing components typically associated with Stirling engines including a heater, a displacer, a regenerator and a pressure containment space that allows the heater, displacer and regenerator to develop pressure changes, but to couple these components intermittently, via valves, to an external system that receives pneumatic power from the Stirling-like system via a direct exchange of working fluid with the Stirling-like system. It is a related object that the valves operate so that the pneumatic power causes a one-directional flow of working fluid in the external system, so that the Stirling-like system and valves function together as a heat-powered compressor. It is a still further object that this compressor be employed to drive a Rankine Cycle, for example for pumping heat or distilling liquids or drying solids.

It is an object of the present invention to use a Stirling-like system, employing components typically associated with Stirling engines including a heater, a first displacer, a first regenerator, and a pressure containment space allowing the heater, first displacer and first regenerator to develop oscillatory pressure changes, and to couple this oscillatory pressure to a second Stirling-like system, employing a second displacer and second regenerator, the second displacer being operated in coordination with the phase of the first displacer so that the second Stirling-like system pumps heat. It is a related object to provide intermittent valved coupling between the second Stirling-like system and separate parts of an external environment, such that working fluid is drawn from part of that external environment into the second Stirling like system, heat is pumped from a cooled part of that working fluid to a heated part of that working fluid inside the second Stirling like system, waste heat is further added to the heated part of that working fluid, and the cooled and heated parts of the working fluid are returned to parts of the external environment for heating and cooling.

These and other objects will become clear from the Specification to follow.

### LIST OF FIGURES

The figures through FIG. 4 describe teachings of the Prior Art.

FIG. 1a is a graphic representation of the algebraic equations of Carnot describing the efficiency of an ideal heat engine and an ideal heat pump, with graphic emphasis on the symmetry of the heat engine and heat pump efficiencies.

FIG. 1b is a variation on FIG. 1a where the heat engine drives the heat pump, but the temperature differences are not symmetric, with the result that a large Coefficient of Performance can be achieved.

FIG. 2a is a pressure-volume diagram of an ideal Carnot cycle.

FIG. 2b is a pressure-volume diagram of an ideal Stirling cycle, with a superimposed curve representing non-ideal performance of a real Stirling engine.

FIG. 3a is a pressure-volume diagram of an ideal Diesel cycle.

FIG. 3b is a pressure-volume diagram of an ideal Otto cycle.

FIG. 4 is a pressure-volume diagram of a hybrid Stirling-Diesel cycle.

FIG. 5 is a pressure-volume diagram for an idealized cycle of the present invention for using a Stirling-like engine to compress working fluid through check valves from a low pressure region to a higher pressure region.

FIG. 6 is a pressure-volume diagram for an idealized cycle of the present invention for using a Stirling-like engine pneumatically coupled to drive a Stirling-like heat pump.

FIG. 7a illustrates components of a Stirling-like system, including a heater and a Stirling subsystem.

FIG. 7b provides a second perspective view of the regenerator of FIG. 7a.

FIG. 8 shows a Stirling-like system coupled via one-way check valves to a distillation system.

FIG. 9 shows details of the distillation system of FIG. 8.

FIG. 10 shows a two-stage Stirling compressor driving a Rankine-cycle heat pump.

FIG. 11 shows a Stirling compressor used in a superheated steam drying system to dry lumber with recycling of condensation heat.

FIG. 12 shows a Stirling subsystem with output check valves and input heat from a concentrating solar collector.

FIG. 13 shows a Stirling subsystem with heat input from a flame.

FIG. 14 shows a more efficient way to transfer the flame heat of FIG. 13 into the working fluid of the Stirling subsystem.

FIG. 15 shows a hybrid Stirling-Diesel engine with an electric motor/generator to start the displacer piston and then be driven by Stirling action, while inlet and outlet check valve transfer pneumatic power to an external load while providing convective removal of waste heat.

FIG. 16 shows a Stirling-like engine that outputs pneumatic power via check valves and inputs heated gas for convective input of heat to drive the system.

FIG. 17 shows a dual-Stirling engine with two regenerator pistons, for heat-powered heat pumping between gaseous working fluids within the system, and with timed exchange of those working fluids with an external environment.

FIG. 18 is a timing diagram showing positions as functions of time for the two regenerator pistons of FIG. 17.

FIG. 19 shows an elaboration of the system of FIG. 17 incorporating the convective heat input of FIG. 16.

FIG. 20 is a timing diagram for FIG. 19 analogous to the timing diagram of FIG. 18 for FIG. 17.

FIG. 21 shows a dual-Stirling engine functionally similar to that of FIG. 17 but employing two displacer pistons and two fixed regenerators.

FIG. 22a through 22q are small iconic diagrams of the dual-Stirling engine of FIG. 21, showing the coordinated piston motions, valve openings and closings, and working fluid flows of that engine.

### SUMMARY OF THE INVENTION

### Preliminary Concepts

The summary begins with a brief continuation of the abstract ideal cycles discussed previously. In graph 500 of FIG. 5, again plotting pressure 502 against volume 504, we view the essential operation of a Stirling Compressor. The cycle begins with no mechanical compression, but simply regenerator heating at constant volume along 506, raising the pressure, for example, from one to two atmospheres with a doubling of absolute temperature. Regenerator heating continues as an outlet valve opens to a large gas reservoir at the high pressure, e.g. two atmospheres, and expansion volume is displaced along segment 508 at constant pressure. A short vertical line indicates transition to heat addition, for example by combustion in a Stirling-Diesel hybrid compressor, and volume expansion continues along the line 510 with circular bumps. The outlet valve closes and a return regenerator stroke lowers the pressure along 512. Then, as with the other valved cycles, we have an exhaust stroke along 514 and 516 and an intake stroke along 518. These strokes could in principle be omitted, except that then there would be less cooling gas exchange, reducing the effectiveness of the regenerator. Tradeoffs for simplicity often entail compromises in efficiency. If the outcome, with efficiency compromises, makes it practical and inexpensive to conserve energy that previously was totally wasted, then the overall approach may be worthwhile. As will be shown in this invention, systems that are “inefficient” in some respects can still provide large fractional reductions in energy consumption in neglected areas of heat pumping and heat recycling at low temperature differentials.

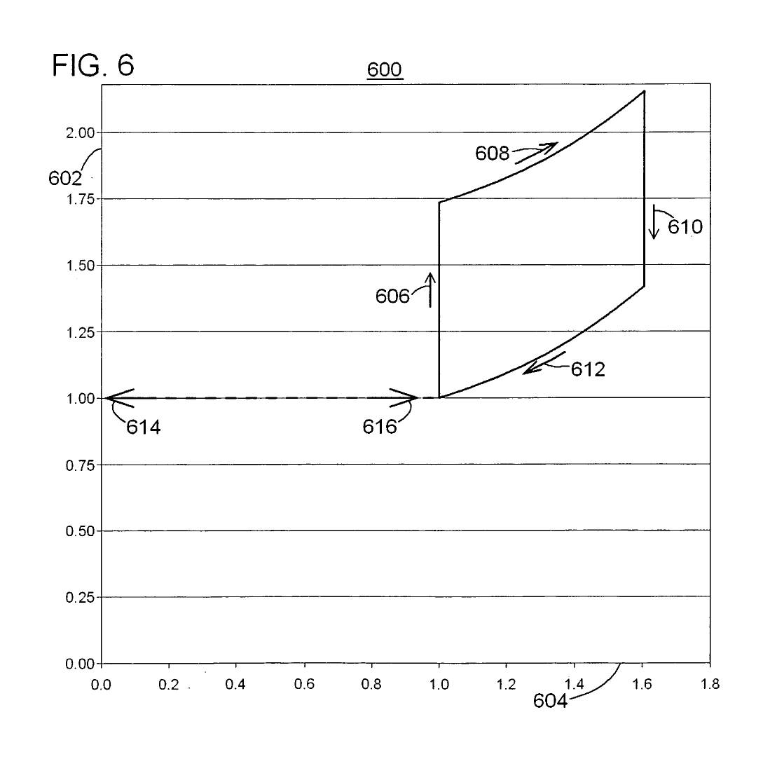

In graph 600 of FIG. 6, the pressure-volume is tilted “backward.” We have gone from large compression strokes in graphs 300 and 350 to a small compression stroke in 400, to no compression prior to heating in 500, and graph 600 we move “beyond no compression,” with moderate efficiency compromises and accompanying great rewards through reduction of previously serious performance and economic losses. Regenerator heating stroke 606 at constant volume is followed by expansion with a combination of regenerator action and heating from a heat source along rising pressure curve 608. Volume axis 604 indicates a low compression ratio while pressure axis 602 indicates low pressure change. Here, the working fluid, a gas, in the core Stirling-like heat engine is expanding against a second gas volume, which is being compressed and which offers increasing resistance to that compression, thus causing the “unexpected” rise of pressure with expansion of the graphed “primary” volume. There is a regenerator cooling stroke along 610 and then decreasing pressure with compression and gas release as the interacting “external” load pressure falls along 612. Exhaust and intake strokes along 614 and 616 rid the system of waste heat in preparation for another power cycle. This graph provides a crude indication of operation of a dual-Stirling-like cycle in which a Stirling-like heat engine pneumatically powers a Stirling-like heat pump.

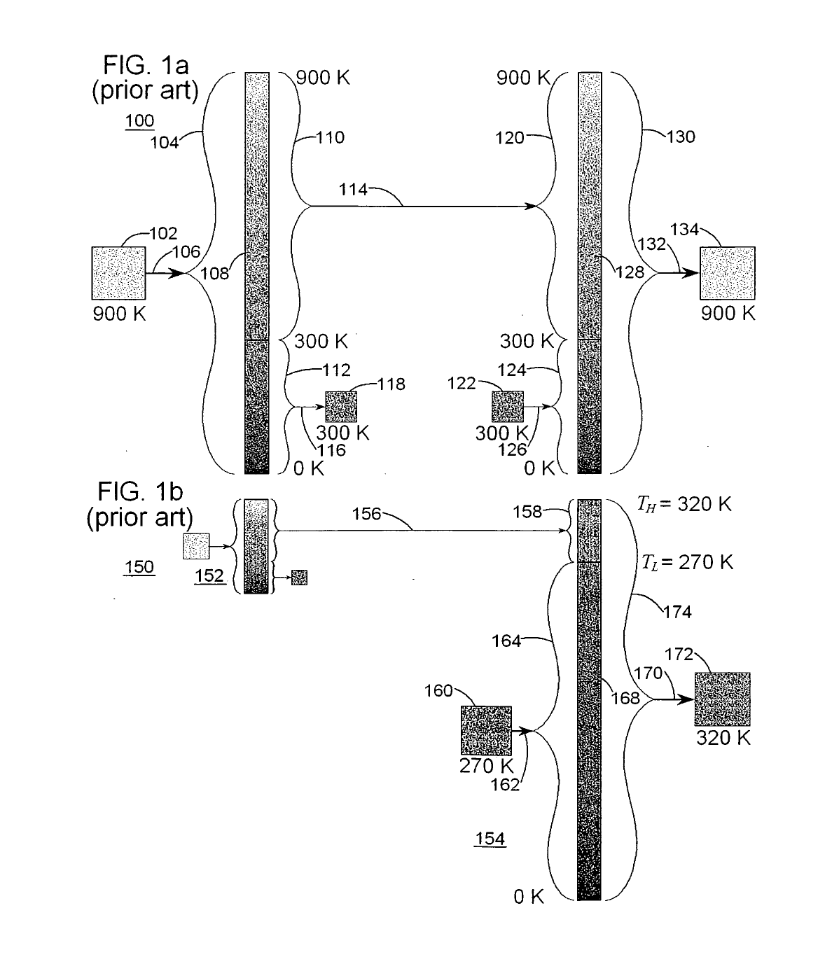

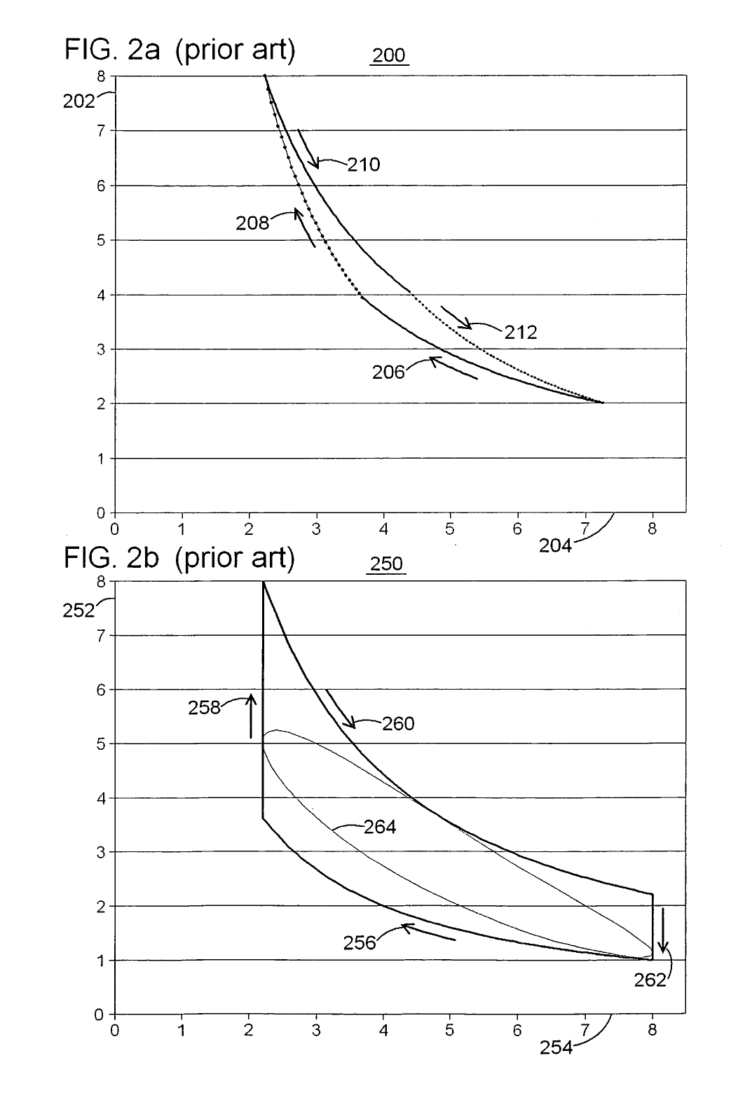

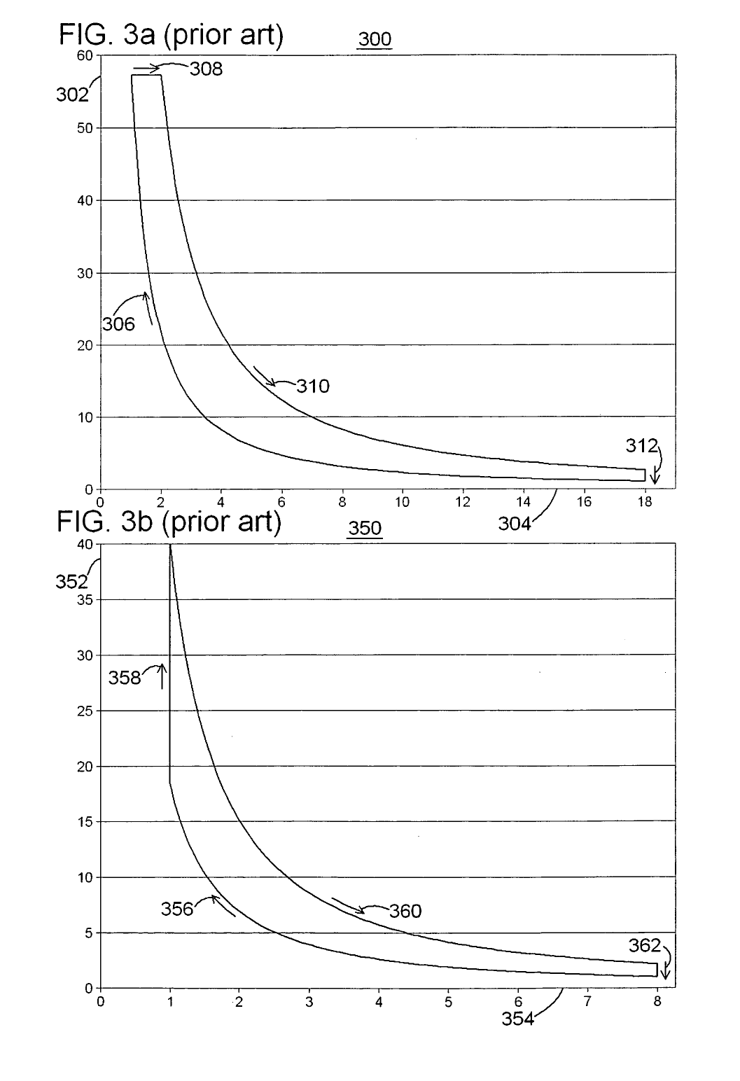

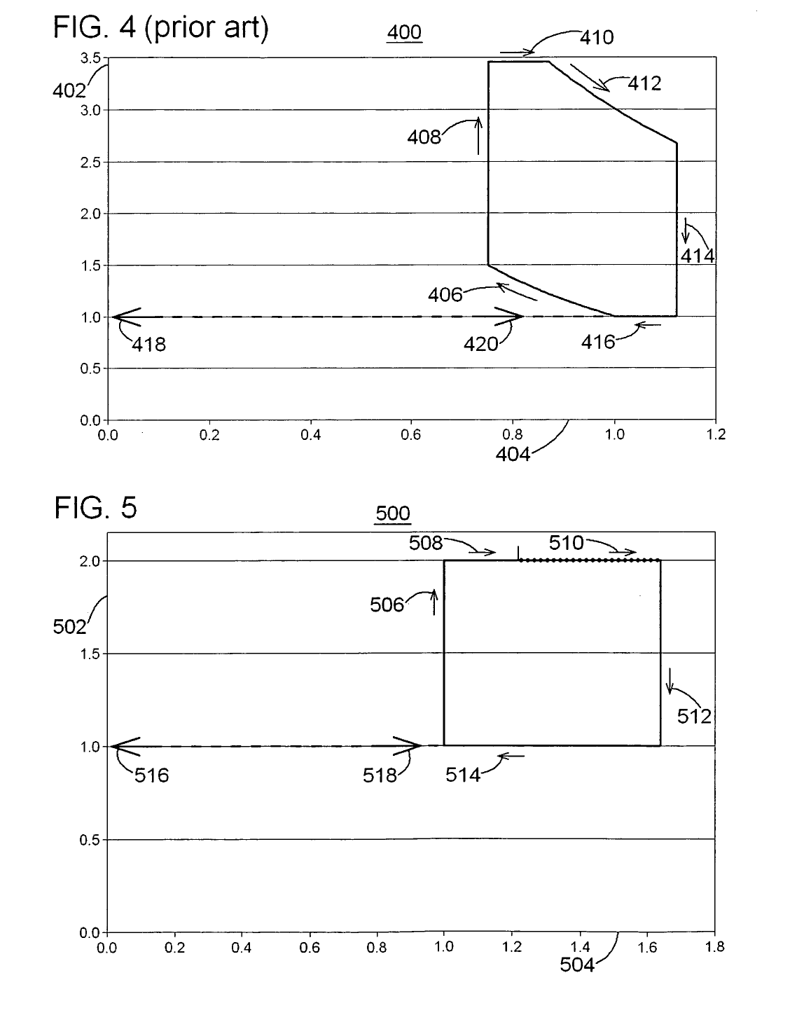

The term “Stirling-like” is used throughout this Specification to describe thermodynamic cycles that employ a regenerator to capture useable heat energy, develop pressure change, and perform pneumatic work against a load. In related usage, the present invention provides for direct pneumatic power production and pneumatic power-to-pumped-heat conversion through novel uses of the “Stirling Subsystem” as described in the above “Background . . . ” section as “ . . . a regenerator and either a displacer piston or a regenerator piston, the latter combining displacement and regeneration functions in a single moving part.” To complete a heat engine or heat pump, one needs at least two heat reservoirs, either drawn upon collectively as a source of power in a heat engine, or heat-pumped from the lower to the higher temperature reservoir in the case of a heat pump that is driven by an external source of mechanical input power. Diagram 150 of FIG. 1b suggests a system with three heat reservoirs, functioning as a thermal autotransformer and using high temperature heat more-or-less directly to power heat pumping from a low-temperature heat source to a heat sink. That output heat sink, as in sink 172 of diagram 150, which is commonly but not necessarily intermediate in temperature between the driving heat source and the low temperature reservoir (160) from which heat is drawn. It is recognized that a system like this can potentially pump relatively small quantities of heat up to a temperature higher than that of the powering heat source, though the examples below will focus on pumping heat to a reservoir, like 172 of diagram 150, at an intermediate temperature between the other two terminals. The objective, then is to accomplish heat pumping by primarily pneumatic means, with reduction or elimination of the power piston function in a system optimized for gas-flow exchange of both pneumatic and thermal energy. The convective exchange of thermal energy is an important component of this new system, as convective exchange goes generally much faster, in systems of comparable dimensions and weight, than combined convection-with-conduction through a pressure containment wall. Convective heat exchange and pneumatic transmission of mechanical power are complementary functions in this new system.

Recalling the electrical transformer or autotransformer analogy, the electrical system invented by Nicolai Tesla and deployed by Westinghouse required alternating current “AC” electric power. The term “AC” will be used below in a generic sense to include oscillatory pneumatic power, which delivers energy in pulsatile fashion but in a one-way direction when pneumatic pressure and volume flow oscillate together in-phase. As in electrical systems, “reactive power” describes a situation with no net one-way flow of energy when pressure and volume flow-rate are in quadrature phase. Reactive pneumatic power is usually counterproductive and to be minimized. Regarding sources of “AC” pneumatic power, timed internal combustion is an excellent example of heat flow in pulses that are timed to cause in-phase variation of pressure and volume displacement. Traditional Stirling engines suffer because it is difficult to modulate the flow of input heat for optimal timing, but the regenerator largely overcomes this limitation. The Stirling Subsystem, including the regenerator and displacer means, is an effective thermal-to-pneumatic DC-to-AC converter, producing an oscillatory pressure variation with flow for volume displacement. A Stirling heat pump is a pneumatic-to-thermal AC-to-DC converter. Thus, we see the beginnings of a thermal DC-to-DC converter that employs the Stirling Subsystem as the necessary intermediary for efficient thermal energy conversion from one temperature differential to another, realizing the “promise” implied by diagram 150.

### The Core Invention

With minor exceptions, embodiments of the present invention use no mechanical piston, avoiding sliding seals, connecting rods and crankshafts and related components. The only mechanical part undergoing large motions is a displacer piston, which may optionally incorporate a regenerator into the moving piston itself and be called a regenerator piston, or which may be a non-permeable piston that drives gas through a separate fixed regenerator. The piston, generally driven by a low-power electric motor, incorporating or working in conjunction with a regenerator, responds to heat from a heater to produce oscillatory pneumatic power. This power may be used in two ways.

In a first power use, the gaseous working fluid of the Stirling-like core system may be a gas to be compressed, and compression may be accomplished through rectification of the oscillatory pneumatic power, typically employing two valves per compressor stage. Two or more Stirling Compressors may be cascaded to handle larger ratios of load pressure. This Stirling compression drives a Rankine cycle including evaporation and condensation with associated uptake and release of heat. An obvious application is Rankine cycle heat pumping, using a closed refrigerant cycle, for example as applied to space heating and air conditioning. Propane is a viable working refrigerant fluid for this purpose, being a viable but far from ideal Stirling working fluid. Extreme high temperatures cause excessive decomposition of propane and must be avoided. An important working fluid in the realm of Stirling compression is water vapor, which is not subject to high-temperature decomposition in typical Stirling-like applications. Applications of water vapor compression include superheated steam drying, distillation, and concentration of solutions, for example, of maple sap to make syrup. An already well developed field is superheated steam drying with electrically driven compression and recovery of the heat of forced condensation. The new invention eliminates the electrical step and the subsequent mechanical steps of the compression process, going straight to thermally-driven pneumatic compression, for example, of water vapor. Among many uses to be contemplated are heat-driven heat-recycling clothes dryers, lumber kilns, apparatus for drying wood chips and other biofuel components, grains and other foods, and manure and sludge. Systems can be powered flexibly by fossil fuels, biofuels, and concentrating solar collectors. The thermal-to-pneumatic energy conversion efficiency is usually moderately low, but the other side of the equation is often an offsetting high Coefficient of Performance or CoP in converting the pneumatic power into complementary processes of evaporation with closely coupled condensation and heat transfer to drive further evaporation. The large fraction of “waste” input heat from this process is mostly retained and used for evaporation and to overcome system heat losses. Overall heat-in to heat-out gains typically range from two to five, with the figures being strongly dependent on design, application, and operating conditions.

When gas is exchanged through a Stirling compressor, heat is carried out of the system by gas convection, eliminating the usual performance-limiting Stirling bottleneck of heat elimination by conduction out of a sealed enclosure. The intermittently-coupled external Rankine system becomes the extended heat sink for the Stirling Compressor. As is suggested in graphs 500 and 600 and specifically the exhaust and intake cycles of 516, 518, 614 and 616, extra convective cooling of the Stirling subsystem, when its valves are open, provides improved heat removal and enhanced performance. Even though atmospheric pressure steam is subjectively “hot,” it is nevertheless much cooler than combustion temperatures, while the Stirling-related thermodynamic properties of steam are moderately good.

In a second category of use of pulsating pneumatic power from a heat-driven Stirling subsystem, the “AC” pressure variation is exploited directly, without valve rectification to a unidirectional flow. Specifically, conventional Stirling heat pumps use cyclic mechanical compression, in phased coordination with regenerator motion, to move heat. Typical existing applications entail large ratios of absolute temperature and take advantage of the high heat capacity ratio or “gamma” of helium gas. For space heating and air conditioning applications, however, the needed ratios of absolute temperature are small, which relaxes the technical requirements of the system design. Air, with its slightly lower heat capacity (7/5, as opposed to 5/3 for helium), varies less in temperature over a given volume compression ratio, but the higher specific heat of air (compared to helium) partly compensates for the smaller temperature fluctuation. Particularly “low lift” (i.e., low absolute temperature ratio) heat pump applications can use a particularly simple coupled-cylinder dual-Stirling design, as will be taught. Higher “lift” applications are performed effectively with a more integrated dual-Stirling design in which a heat engine regenerator piston travels in the same cylindrical space as the heat pump regenerator, in overlapping ranges of motion so that the effective dead volume of the system is extremely low.

Both categories of application share the same driving system, which is a Stirling subsystem producing oscillatory pressure variation and then opening valves to a cooling heat exchange environment or coupled system.

### DETAILED DESCRIPTION OF EMBODIMENTS

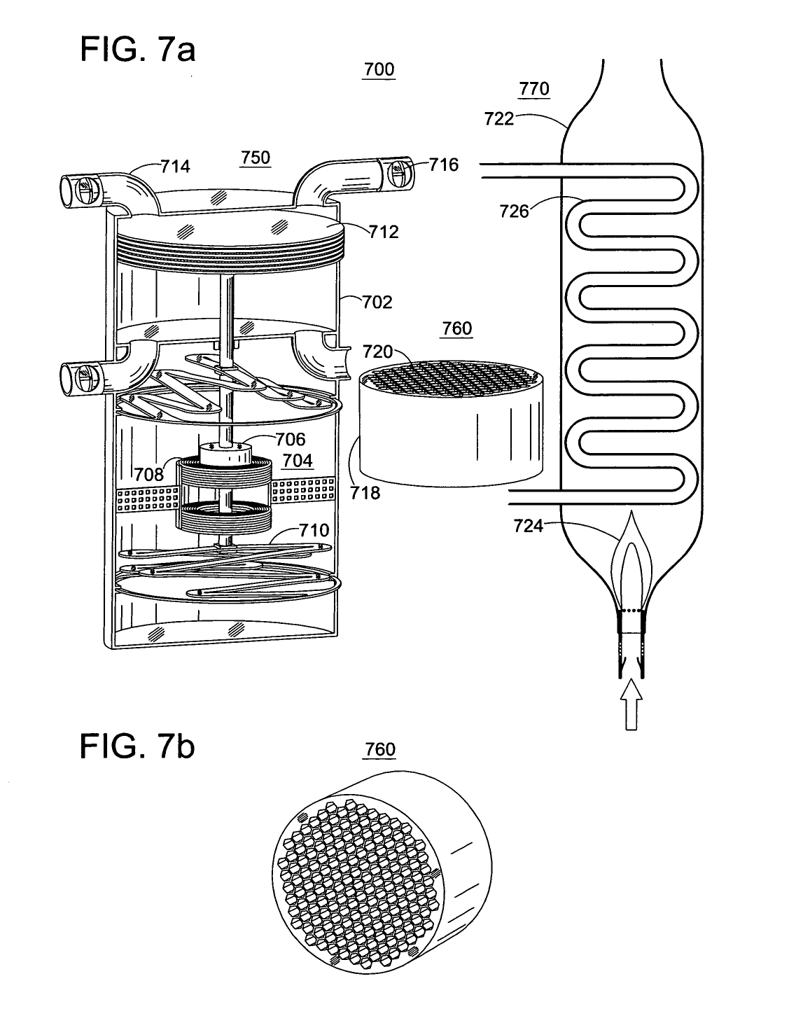

Going through various embodiments of the invention, FIG. 7a illustrates components of one example of a Stirling Subsystem 700. On the left, displacer apparatus 750 includes a housing 702 capable of confining the internal volume of working fluid for pressure change. Further included, motor 704 employs magnet 706 and coil pair 708 in a simple embodiment, while more complicated and powerful motor examples will be shown below, which are already well known in the art. Flat spring 710, and a similar flat spring above motor 704, resonate the moving mass for efficient cyclic motion with low power input. These optional flat springs also provide centered linear guidance of the piston motion, creating an option for no-sliding contact guidance of the displacer motion. Displacer piston 712 is surrounded by a displacement chamber, ported with two inlet/outlet pipes above, including pipe 714, and two more below. One or more ports optionally include gas valves, for example a gate valve illustrated at 716, with actuation means assumed but not shown here. To the right of apparatus 750 is regenerator 760, including honeycomb holes 720 in body 718. Many regenerator configurations, both fixed and as moving regenerator pistons, are known in the art, and it is understood that the coarse honeycomb mesh 720 is only illustrative, while a much finer mesh would usually be required. Other well known regenerator approaches include ceramic foams, fused-together crossing fine wires, and pebble beds, this latter option being inexpensive but usually applicable only for fixed regenerators. FIG. 7b shows a different perspective view of regenerator 760 for clarity. On the right of FIG. 7a, heater 770 includes a housing 722, a flame 724, and a heat exchange pipe 726, here drawn as serpentine, though a coiled pipe or other configuration could perform well.

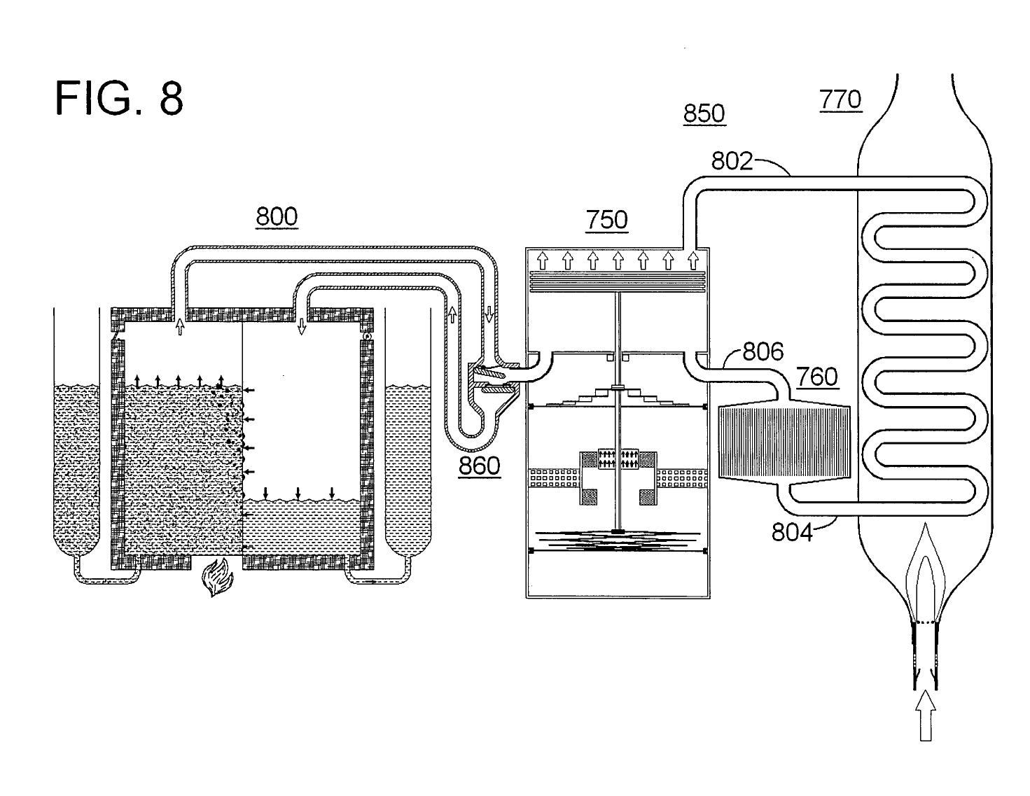

FIG. 8 shows the components of FIG. 7a in two-dimensional cross-section in a system for mechanical distillation or for concentration of a solute, for example, for the efficient evaporative concentration of maple sugar starting from highly dilute maple sap. The assembled Stirling compressor system 850 includes components from drawing 700, including displacer apparatus 750, regenerator 760 (here shown in section, with a finer mesh, and with a housing) and heater 770. These components are interconnected by pipes 802 from the displacer hot side to the heater, pipe 804 from the other side of the heater to the hot side of regenerator 760, and pipe 806 completing the loop back from the regenerator cool side to the displacer apparatus. Valve assembly 860 will be described below.

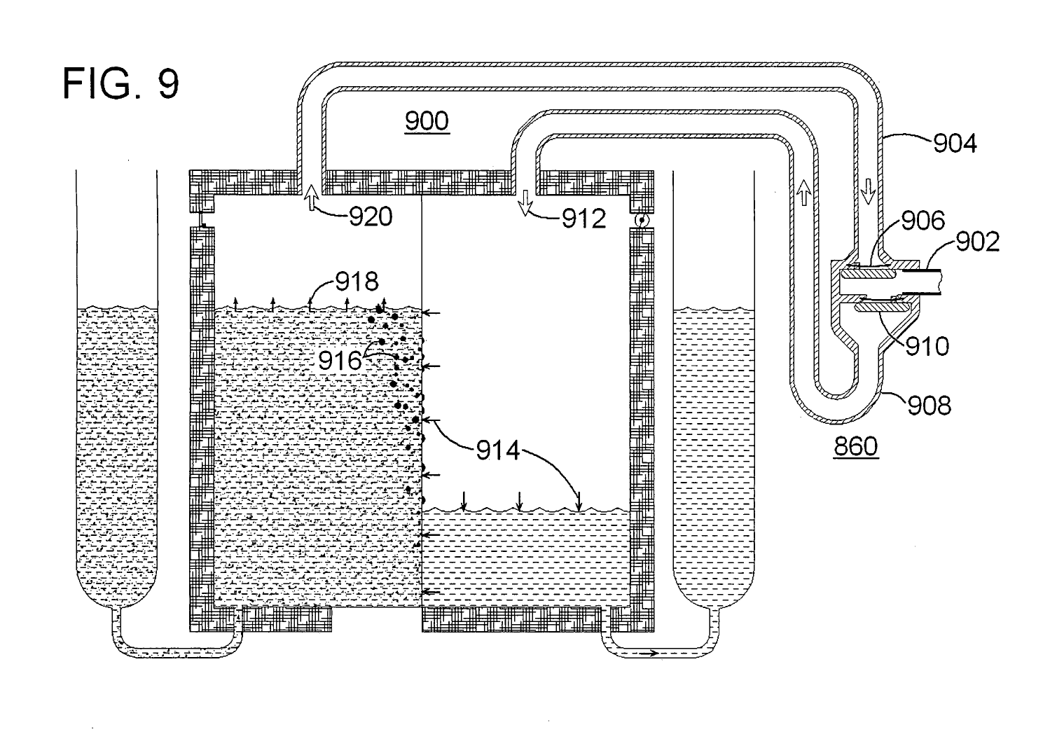

The valve 860 and distillation system 800 on the left of FIG. 8 are shown in greater detail in FIG. 9 with drawing 900. Pipe 902 interconnects the displacer apparatus 750 (of FIG. 7) to valve assembly 860, which includes an inlet pipe 904, a movable inlet valve gate 902 spring-restored by a simple bent-wire spring, an outlet pipe 908, and a movable outlet valve gate 910. The insulated distillation reservoir includes a high pressure inlet 912 to a chamber with condensation indicated by arrows 912 into water and into a thermal-conductive mechanical barrier. Vapor bubbles 916 rise from the opposite low-pressure side of this barrier, and vapor rises directly from surface evaporation as indicated by arrows 918, with out-flow 920 completing the vapor circuit with heat-recycling exchange.

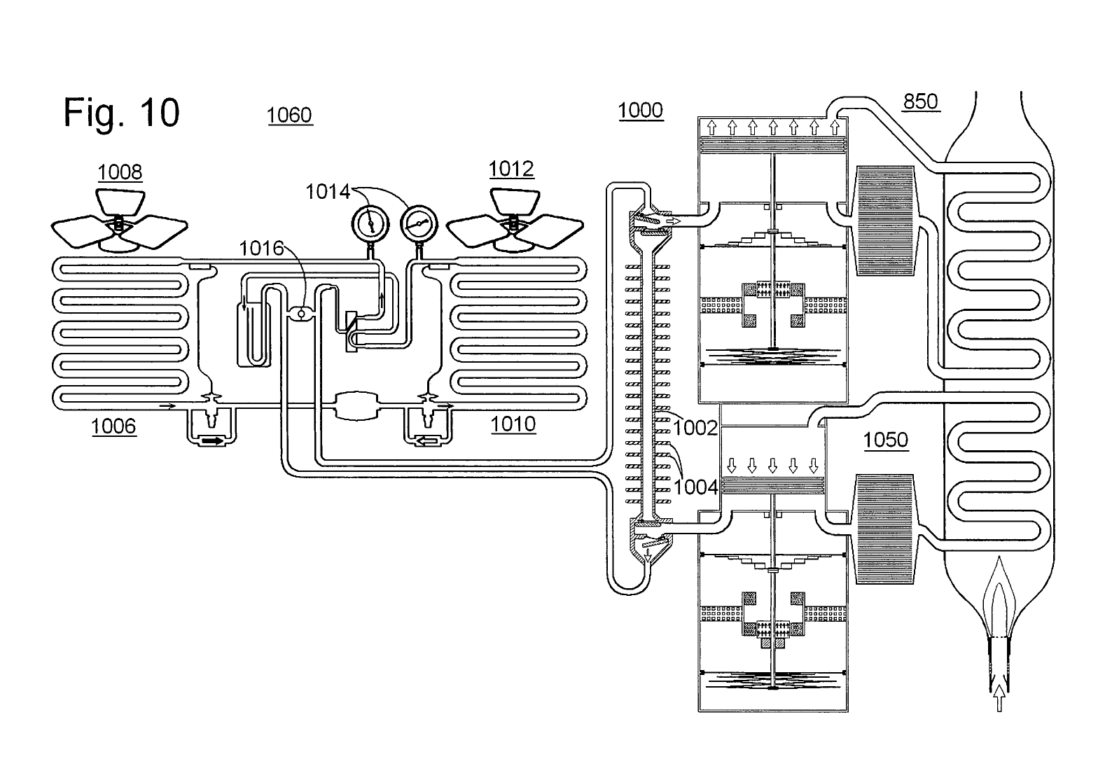

Drawing 1000 of FIG. 10 illustrates a two-stage Stirling Compressor, each stage being similar to the Stirling Subsystem of diagram 800, with subsystem 850 shown on top, modified to share a heater flue with a similar subsystem 1050 below. 1050 differs, however, in using a smaller displacer piston to work with a smaller, denser compressed gas volume coming from 850. The two compressors are interconnected via twin check valve assemblies making up assembly This two-stage system shares a common burner and flue with two serpentine heater pipes. The electromagnetic spring-resonated motive means for oscillating the displacer pistons are the same in the two Stirling Subsystems, while the higher-pressure displacer piston is smaller, to displace the same mass of gas as the upper piston, but at higher pressure and consequently less volume. Interconnection pipe 1002 includes heat-dissipating fins 1004, performing an intercooler function. The two displacers may optionally be operated in opposite phases, as suggested by the diagram, while a counterweight below the permanent magnet (arrows) in the lower motor unit balances the system, such that there is little or no net vertical motion of the system center-of-gravity as the two pistons oscillate in opposite phases. Electronic controls (not shown) are optionally equipped to maintain opposite phasing and a balance of oscillatory amplitudes to minimize vibration. Gas from compression stage-1 is cooled in an intercooler fin-tube pipe before further stage-2 compression, with the gas then proceeding to a Rankine cycle heat pump of conventional configuration. Reviewing only key subassemblies of this familiar system 1060, condenser 1006 receives forced convection from motor and fan assembly 1008, while evaporator 1010 similarly receives forced convection from fan 1012. Pressure gauges 1014 indicate the state of the system. Various valves, filters and traps complete the familiar function. These blowers, valves, sensors and associated valve regulators, etc., will be recognized by those familiar with Ranking Cycle heat pump systems. Note a reversing valve to switch between air conditioning and heating modes, all of which are powered primarily by combustion power coming from the right-hand system. A valve 1016 in the middle of the Rankine system allows the high and low pressure sides to be momentarily short-circuited, as may be necessary to get the Stirling-like system started or re-started. If there is too much back pressure on the Stirling Subsystem checkvalves, such that they fail to open, then there will be no convective heat removal from the Stirling-like cylinders, resulting an loss of the needed temperature gradient across the regenerators. To avoid this latch-up situation, the pneumatic load is short-circuited to remove the excess pressure, allow the valves to open, and cause the low-temperature side of the regenerator to be cooled by convection until the needed temperature differential is re-established. One way checkvalves in the Rankine system (not shown), may be included to prevent energy-wasting back flow from the condenser to the evaporator when the relief valve is opened to start or re-start the Stirling Compressor.

The working fluid for a Rankine Cycle space heating of this sort must have appropriate thermodynamic properties, especially a critical temperature in the right range, and be environmentally acceptable. The fluid must also withstand the highest temperatures of the Stirling Subsystem without excessive decomposition. Propane is an example from a very short list of potential working fluids. Most other refrigerants that might be used in the Rankine Cycle have poorer properties from the Stirling Subsystem standpoint, and there are problems of high-temperature decomposition. Even propane has limits beyond which an excess of non-condensing decomposition products will degrade system performance—those include ethylene, methane and hydrogen, while propylene will be produced but will cycle to some extent with the propane. The equilibrium concentration of the byproducts increases with temperature, setting a practical upper limit to the hot-side temperature of this system. A most detailed examination shows that solar-heat-driven systems of this sort have good potential, while combustion-powered systems cannot take maximum advantage of the high temperatures that are readily provided in an efficient burner. As is seen in other examples, water vapor as a Rankine Cycle working fluid is tolerant of high temperatures and has better thermodynamic properties than propane, from a Stirling Subsystem viewpoint.

FIG. 11 suggests a broad generalization of the use of a Stirling Compressor for drying. In this example, a lumber-drying kiln 1100 is operated at just above atmospheric pressure. The kiln is pre-heated and allowed to fill and over-fill with steam, until most of the air is driven out through cracks and the building and nearly pure steam remains inside. Since only a relatively small temperature rise is needed to reach a desired drying rate for lumber, without the warpage caused by too-fast drying, a single-stage Stirling Compressor 850 is shown in this example, while the Rankine Cycle space-heating heat pump system described previously is likely to require at least two compression stages. In system 1100, once the kiln is filled with nearly pure steam, added steam from evaporation is collected, compressed, and caused to condense in a heat exchanger 1102 that re-superheats the remaining steam in the kiln, thus powering continued evaporation with a significant fraction of recycled heat. Condensate liquid 1104 collects in the bottom of the condenser and is released controllably by valve 1106, so as not to lose the elevated vapor pressure. However, it is possible to detect accumulation of non-condensing gas at the bottom of the condenser, inhibiting performance, and valve 1106 is occasionally opened enough to allow some vapor to escape, sufficient to carry out accumulating non-condensing gas. The excess heat of fuel combustion overcomes insulation heat loss and provides a sufficient excess of un-recycled steam to keep a slightly positive interior pressure, so that steam leaks out, instead of air leaking in and inhibiting the condensation process.

System 1200 of FIG. 12 shows that a Stirling Compressor can be powered by a solar collector 1250, in this example, a concentrating parabolic trough collector. In a system of this sort, the working fluid (gas) of the Stirling Subsystem circulates directly through the solar-heated tubing of the collector. Labeled interconnecting pipes 1202 and 1204 from the collector to displacer apparatus 750 and regenerator 760 will reappear in later systems that optionally employ solar heat input.

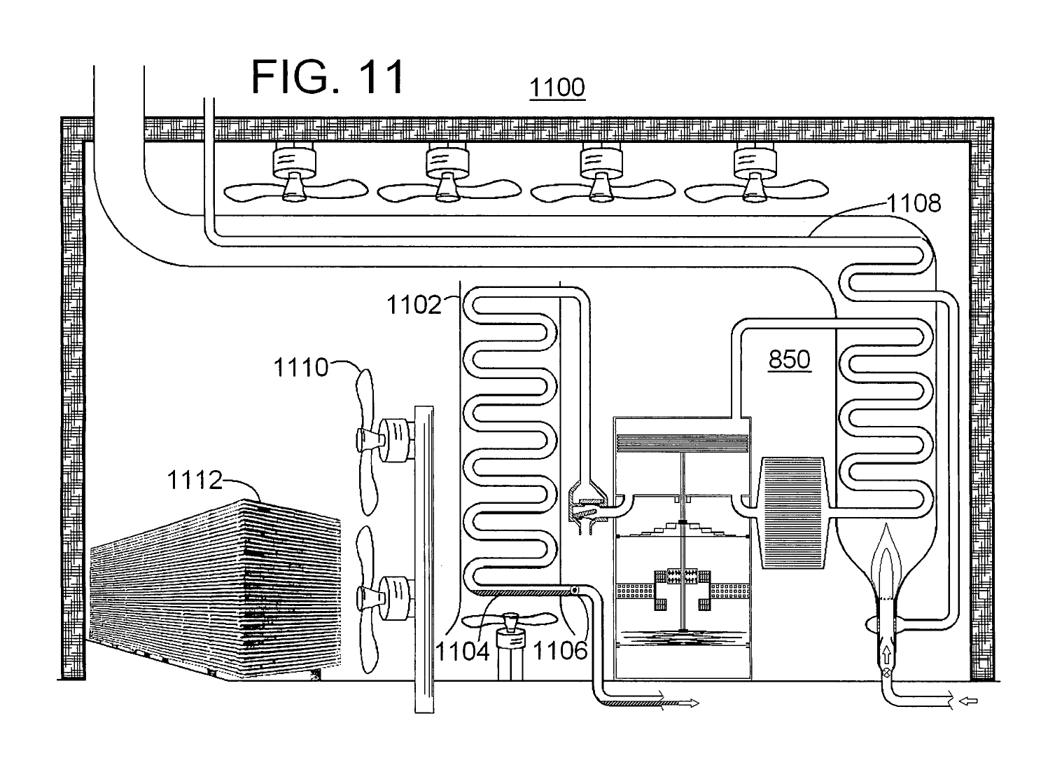

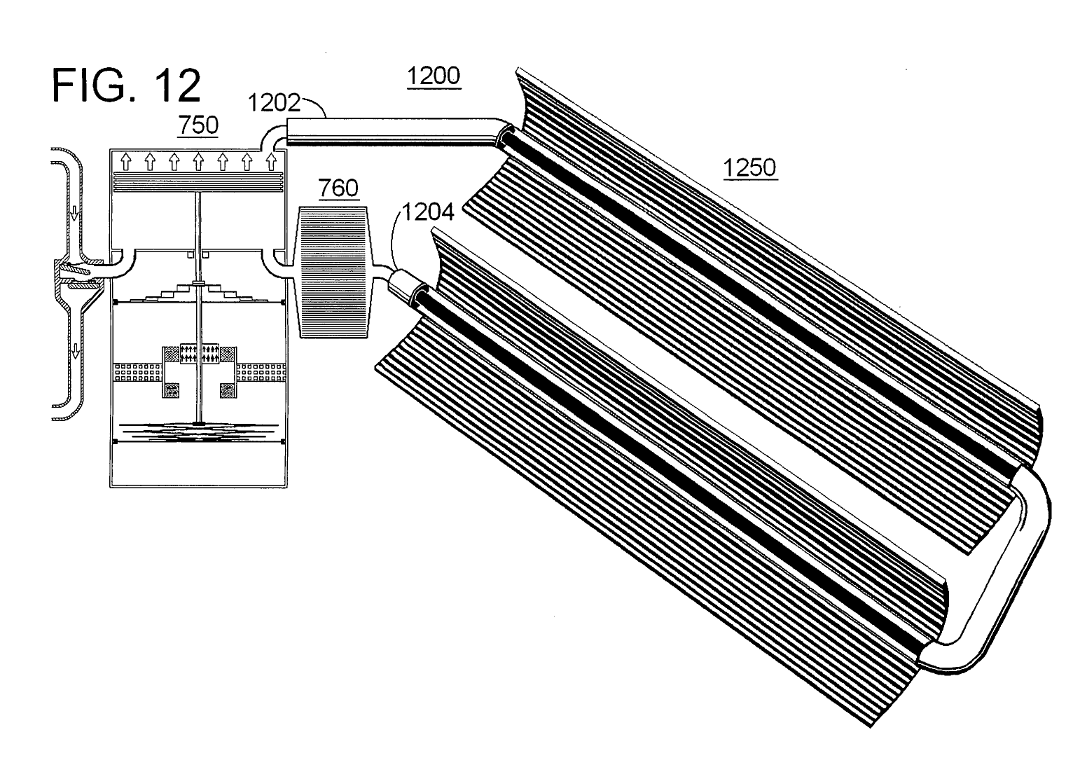

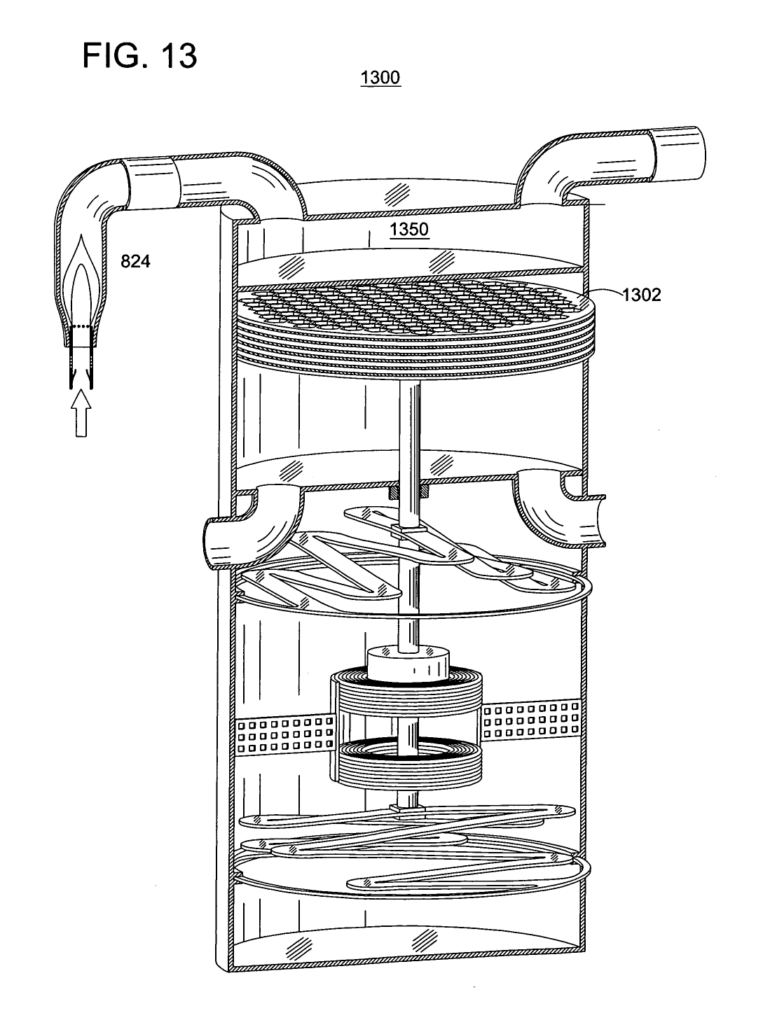

Subsystem 1300 of FIG. 13 shows a perspective view in anticipation of more complicated “two-terminal” and “three terminal” thermal transformers to be described. The electrically-driven displacer piston operates in a cylinder with four connecting pipes, two above and two below, as in displacer assembly 750 of drawing 700, while optional gate valves like 716 are shown there. Assembly 1300 differs from 750 by including a heat source 824, illustrated here by a flame and typical gas burner apparatus, the flame heating a chamber 1350 that provides heat to the components below by conduction. This subsystem also employs a moving regenerator piston 1302, thus differing from 750 with its displacer piston. 1302 is illustrated as a coarse axial honeycomb mesh. Again, it is understood that a practical mesh would be much finer, and in fact, manufactured “honeycomb” meshes in ceramic filter components are commonly square rather than hexagonal grids. A more sophisticated and efficient variation on the illustrated system will now be shown in section view.

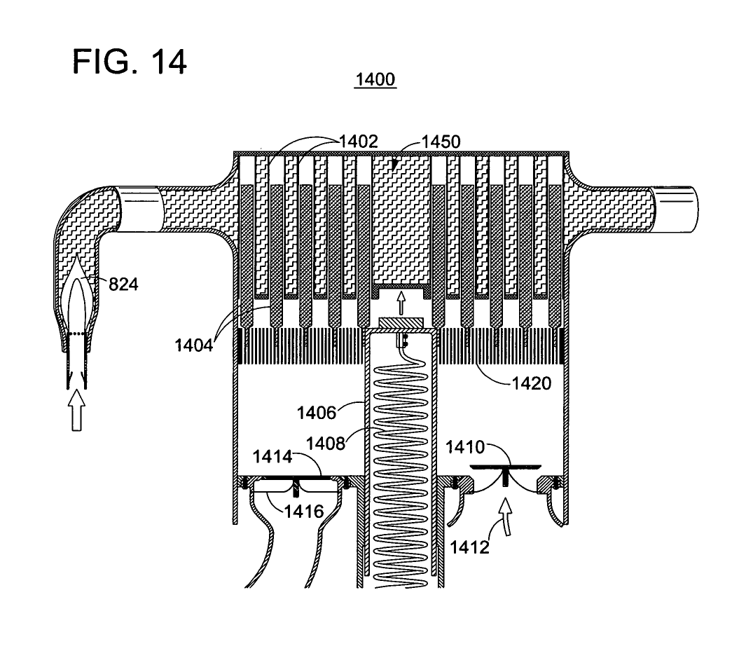

Subsystem 1400 of FIG. 14 shows an example of the convoluted interface promised in the previous paragraph. The honeycomb regenerator mesh of 1420 is viewed in cross section, much finer than the illustration of 1300 but still more coarse than is likely to be used in practice. Solid “fingers” 1404 extend upward from the regenerator mesh into channels 1402 that are surrounded by burner-heated gas. Viewed from above (not shown), these fingers and containing cylinders would be seen as a grid with combustion gases flowing across and around the “forest” of cylinders. The region of heated gas is hatched with a stairstep pattern. Note that this topology provides for some degree of timing of heat transfer. Inflow of heat is maximized as the regenerator piston progresses from mid-stroke to bottom-dead-center, exposing working fluid both to the hot interior cylinder walls and also to the exterior finger surfaces, which are reheated when the fingers are more fully inserted in the cylinders. The regenerator piston is spring-restored by a helical spring 1408, which is contained in a relatively large telescoping cylindrical shaft 1406. The spring ends are aligned to the center-axis and clamped (lower end not shown), allowing operation in alternating compression and tension. Passive poppet check valves 1410 and 1414 are illustrated at the bottom of the cylinder, with each poppet restored to a normally-closed position by flexible wires like wire 1416. Inlet check valve 1410 is shown open, allowing inflow 1412, as would occur when regenerator 1420 is approaching its top position and the cool gas volume below 1420 approaches its maximum, causing overall gas contraction.

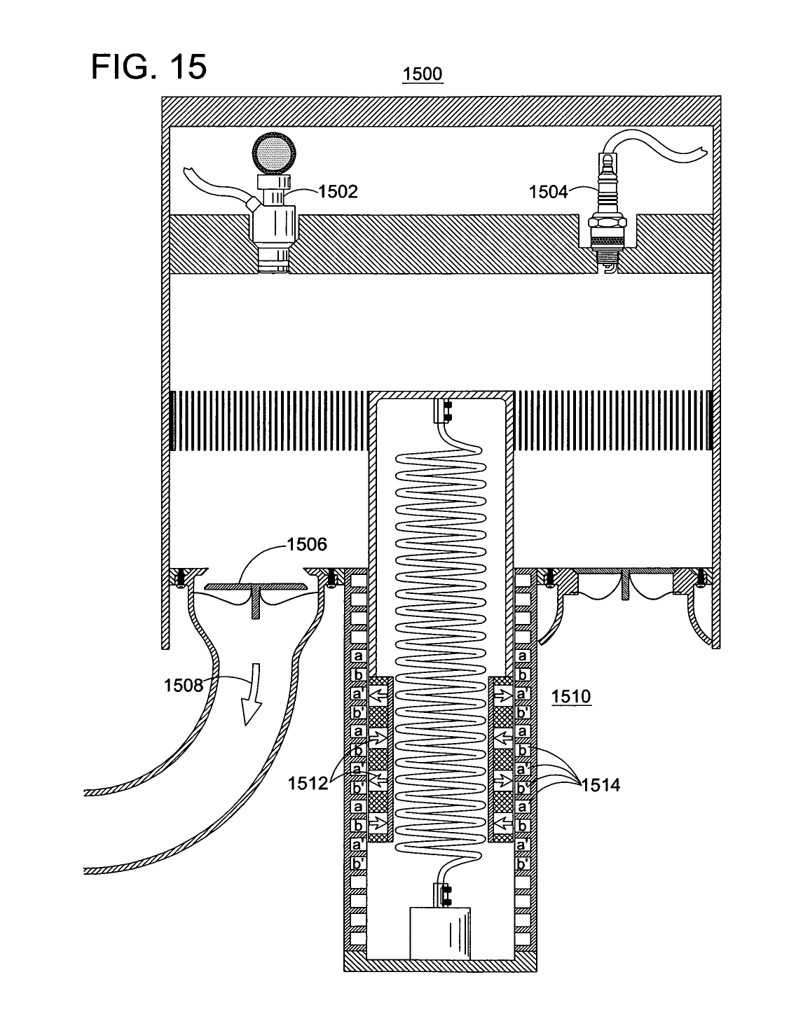

System 1500 of FIG. 15 illustrates a hybrid Stirling-Diesel configuration. A fuel injector 1502 is shown on the upper left, and a sparkplug 1504 on the upper right, typically needed only to initiate combustion until the system is pre-heated. Following pre-heat, the regenerator retains and transfers sufficient heat that fuel injects into air and combusts on contact, in a smooth regenerated Diesel action. Open outlet check valve 1506 is similar to closed outlet check valve 1414, while arrow 1508 represents the out-flow of gas. The regenerator piston is spring-restored, as in system 1400, while motion is controlled by a linear magnetic motor/generator 1510 consisting of permanent radially-poled magnets 1512 (arrows) in the moving shaft and phase coils 1514 in a ferromagnetic stator yoke. 1510 is used in motor mode for starting the system but, as is now discussed, the piston can begin to self-oscillate and deliver power to 1510 acting as a generator.

Normally, power generation in a Stirling engine with one power piston requires a separate displacer piston moving in a different oscillatory phase, typically with roughly a 90 degree phase difference. This limitation is overcome in interconnected multi-cylinder configurations, where phase-shifted interactions among cylinders give rise to self-oscillation of the combined displacer/power pistons. It normally does not work, however, to have a single piston with a wide piston head acting as a displacer piston or regenerator piston and also as a power piston. As illustrated here, the lower part of the piston assembly is a thick piston shaft, whose opposite end travels into a region of relatively constant pressure, potentially acting as a power piston, if the pressure were in the correct phase. For ideal lossless regenerator action, pressure varies in phase with piston displacement, a “reactive” phase delivering no net power. For driving a self-oscillating regenerator piston with a thick shaft rising from and sinking into a region of relatively constant pressure, the pressure phase must shift away from reactive and toward a power phase, in-phase with velocity rather than displacement. When pneumatic power is drawn from the system as described, however, and specifically when valves open after some initial pressure change, allowing flow that inhibits or stops that pressure change from continuing in the same direction, then this variety of specific loading conditions causes the wall-penetrating “power piston area” to deliver power through the piston shaft to the generating apparatus. Thus, for example, when passive check valves rectify the fluid flow into a fluid load with roughly constant back pressure, the check valves remain closed following the start of piston motion in a given direction, while their delayed opening “clamps” the pressure profile against further significant pressure increase until the displacer piston comes to a stop and the opened valve re-closes. The piston motor/generator will require electric power input until conditions are achieved that provide an appropriate combination of load back pressure, regenerator-produced pressure oscillation, and valve openings following pressure change, increasing or decreasing. With energy storage for starting, as with a battery, a system of this type can start from battery power, establish conditions for power generation, recharge the battery, and continue to produce surplus electric power. In fact, an appropriate adaptive level of electric power consumption must then be maintained, in order to prevent excess oscillation amplitude and banging against mechanical limits. On the other hand, an appropriate kind of pressure loading of the inlet and outlet valves is required in order for there to be any self-oscillation. There are known alternative approaches to preventing excess oscillation, for example the small un-numbered end feature on the top of piston 1406 and the receiving dash-pot feature that the piston feature pushes into near top-dead-center. Since the generator function of the motor/generator is required for starting and establishing regenerative piston oscillation, however, a small incremental expense brings about the advantage of generating from excess piston power rather than dissipating that excess.

This hybrid Diesel-Stirling system for delivering both pneumatic and electric power has the advantage of forced convective removal of heat via the lower-left valve 1506, which functions as an exhaust valve, while the lower left valve, shown closed here, functions as the intake valve. Note that there is little or no compression stroke in this cycle, depending on operation of the thick center shaft. P-V diagram 500 of FIG. 5 included a discussion of this situation, which is less efficient than a hybrid Stirling-Diesel cycle with moderate compression. The larger objective here, however, is not optimum efficiency, but moderate efficiency combined with simplicity and low cost, to go after the very large market for making considerably better use of heating fuel, delivering “bonus” pumped heat energy and possibly bonus electric power.

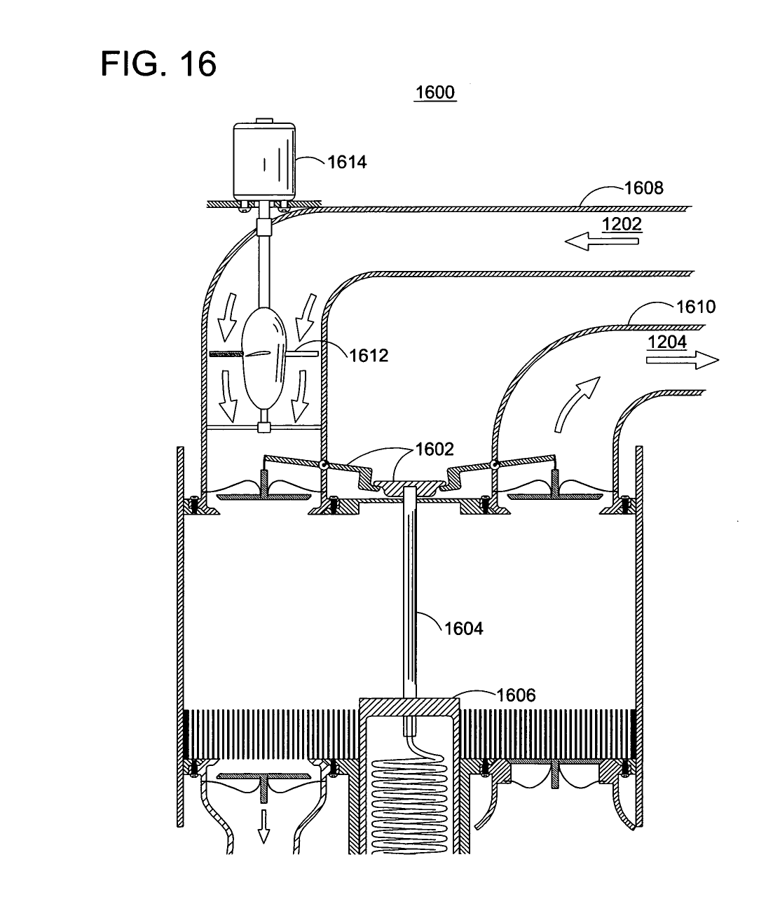

System 1600 of FIG. 16 shows a variation on system 1500 in which powering heat is brought into the upper part of the cylinder via 1608 directly as hot gas, when the regenerator piston is near bottom-dead-center, via valves that are opened by a linear cam 1602 atop a thin shaft 1604 extending from the center 1606 of the regenerator piston. A motor 1614 drives a blower 1612 that moves heated gas through from above when the valves open, with gas exiting via 1610. As illustrated, the blower consists of moderately high-speed blades operating and low attack angles so that the blades do not stall with the valves close and prevent axial flow. The objective is a blower that does not dissipate excess energy while spinning against a stopped air flow. The heat source for this system may advantageously be the solar collector system 1250 of diagram 1200, as suggested by the numbers 1202 and 1204 on the input and output gas streams—these are the numbers of the solar collector connecting pipes.

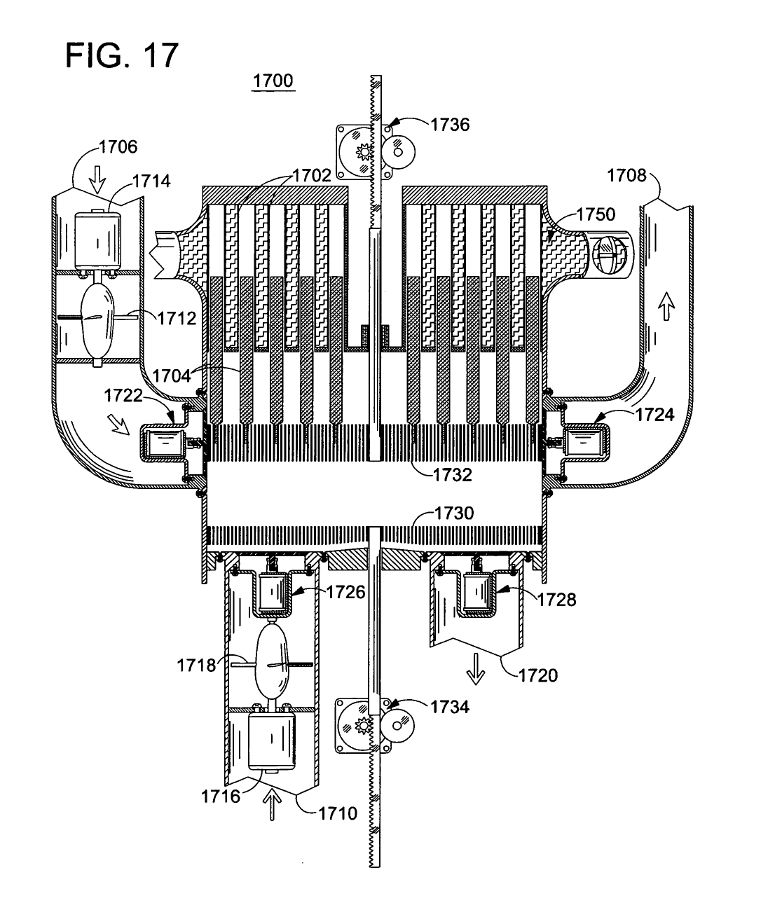

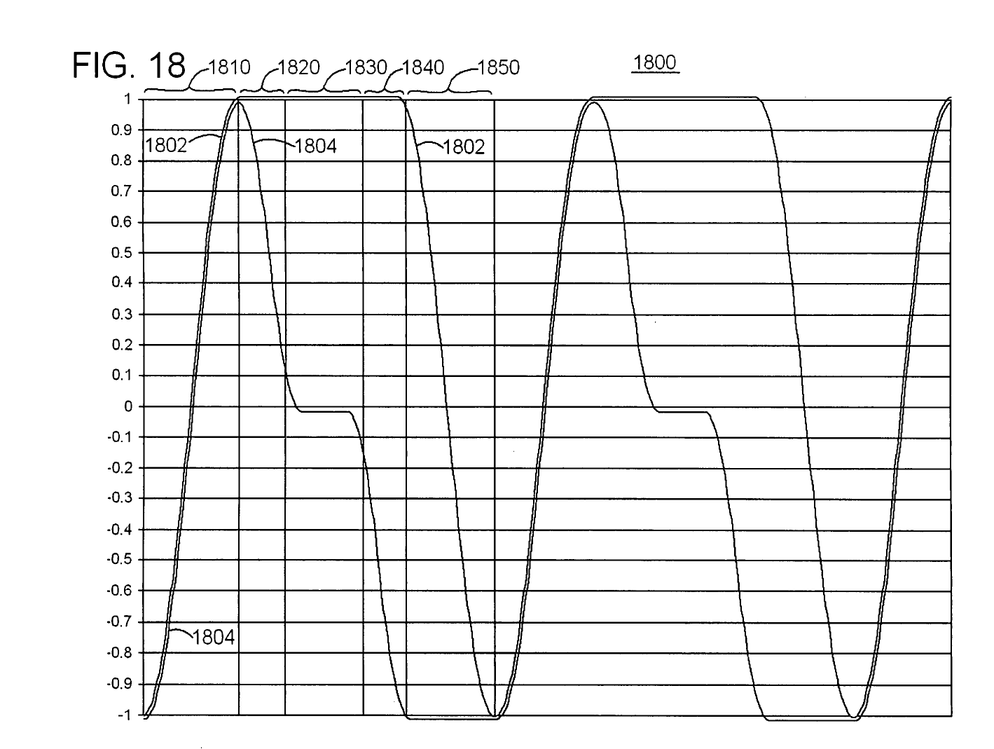

System 1700 of FIG. 17 shows the promised dual-Stirling engine operating as a heat-powered heat pump. Many of the components are familiar from earlier illustrations. A heat source, for example from combustion (not shown) or from a solar collector (not shown) heats a heat exchange region 1750 similar to that previewed in subsystem 1400. Here, channels 1702 receive fingers 1704 for enhanced and partly timed heat transfer. Warm gas flows in intermittently through the upper section via 1706 and out intermittently via 1708. Gas flows similarly through the lower section inward via 1710 and outward via 1720. Blower blades 1712 and blower motor 1714 near 1706 are similar to ones shown in 1600, while a similar motor 1716 and blades 1718 drive the lower circuit, with gas exiting intermittently via 1720. Flow is controlled by solenoid valves 1722 and 1724 in the upper path and valves 1726 and 1728 in the lower path. There are two independently controlled regenerators, thinner regenerator 1730 interfacing between cold and warm and thicker regenerator 1732 interfacing across the much larger temperature differential between warm and hot. Axial motion of lower regenerator piston 1730 is controlled by a motor and rack-and-pinion assembly 1734, while motion of upper regenerator piston 1732 is controlled by a similar assembly 1736. In summary, the system includes two regenerator pistons, two blowers, and four solenoid-operated gas valves. The regenerator pistons are driven controllably, optionally including with stop-and-start motion, by the servomotors and rack-and-pinion gears. Stepper motors have advantageous characteristics for this kind of a job, with controllable quick starts and stops and high torque.

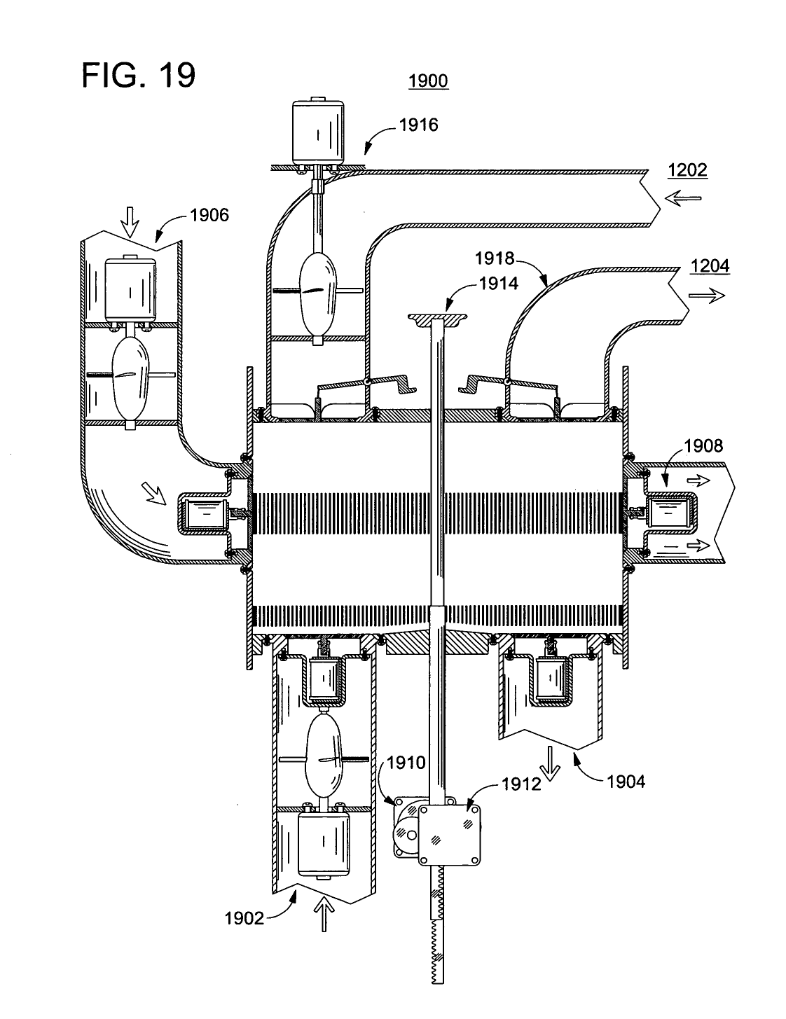

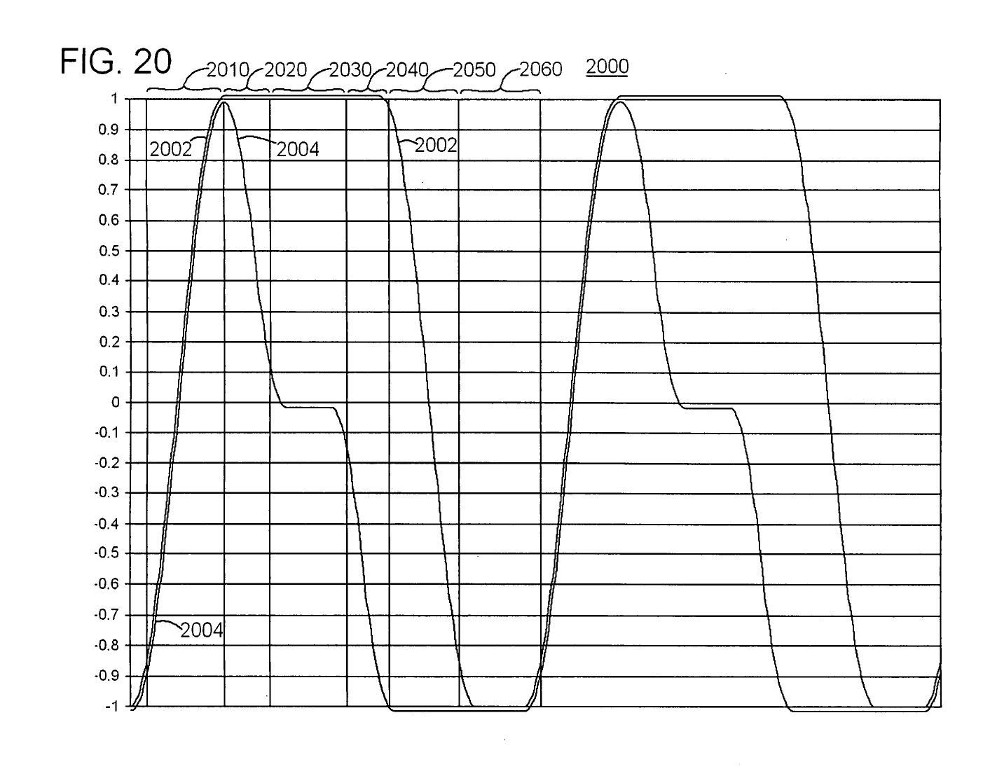

An optional operating cycle for system 1800 is illustrated in diagram 1800 of FIG. 19. Trace 1802 follows the vertical position-versus-time of the upper regenerator, interfacing between high temperature and intermediate temperature, while trace 1804 follows the thinner lower regenerator similarly, operating between intermediate and low temperatures. The two regenerator traces go up together in time region 1810, representing an upward regenerator piston motion in 1800 with a resulting cooling of the cylinder gas volume. “Up” in 1800 represents high position in the diagram 1700 and lowered temperature. The heat-pump regenerator trace 1804 then descends halfway in region 1820. It heats air as it moves, while the side encountering cool air is cooled by the lowered temperature of the thermally-decompressed air. The regenerator piston stops midway in region 1830, while all four valves open to exchange warm air across above 1804 and cold air across below 1804. The valves re-close and 1804 completes its “downward” stroke in time region 1840, continuing to pass through low-pressure, adiabatically cooled air. The “heat engine” regenerator then descends in a heating direction in time region 1850, raising the pressure in the system and adiabatically heating all the gases in the system. When the two pistons subsequently rise in a new repetition of 1810, the thinner “heat pump” piston is moving in an air-cooling direction through air that is relatively warmer, due to the average pressure increase compared to the times of the down-strokes in regions 1820 and 1840. The net effect is always to move the warm side of the lower heat-pump piston through compression-heated air, and the cool side of that piston through decompression-cooled air. This is the well known action that makes conventional Stirling heat pumps perform. Conventionally, however, the heat pump regenerator responds to pressure changes driven by a mechanical power piston. In the mechanical system of 1700, with the timing method illustrated in 1800, the pressure changes are driven directly, pneumatically, by a Stirling heat engine, embodied in the high-temperature heat source and the thicker regenerator piston plus its linear-motor actuation system and working in conjunction with the timed valves. Pressure changes occur with the valves closed, in Stirling-like fashion. Valve-open gas exchanges then occur when the regenerators are coming to a stop, or fully stopped, or just beginning to move. Conceptually, there is a time alternation between closed-system Stirling-like pressure change and open-system thermal exchange of gases. Cool gases go into the bottom of the system and come out colder, giving up their heat to the warmer gases above. Warm gases come across the middle, are captured and heated by Stirling-like action, and emerge hotter, carrying pumped heat plus combustion heat. Thus, the system has a heat gain, or heating CoP, exceeding unity. The cool side of the system has a cooling CoP, not augmented by waste heat but nevertheless useful for air conditioning, including direct solar-powered air conditioning.

Drawing 1900 of FIG. 19 combines the lower portion of diagram 1700 with the direct hot gas exchange apparatus of diagram 1600. There are six paired inlet/outlet ports: 1201 and 1204, optionally recognized from 1200 as solar collector ports for hot air; 1902 and 1904 for cold air exchange from below; and 1906 and 1908 for warm air exchange across the middle. Rack and pinion drive and motor 1910 are similar to 1734 of 1700, while similar drive 1736 of 1700 appears flipped around and over at 1912, partially covering 1910. This is a workable configuration if the rack for 1910 extends from the lower surface of the outer concentric shaft extending upward to the lower regenerator. Between high temperature channels 1916 and 1918 one finds cam 1914, similar to the center part of cam mechanism 1602 of 1600 but in a middle position at 1914.

The timing diagram for 1900 is similar to the one for 1700 with one exception. Respective numbers 2002, 2004, 2010, 2020, 2030, 2040 and 2050 correspond to numbers 1802, 1804, 1810, 1820, 1830, 1840 and 1850 of the earlier diagram, while the start of the next operating cycle is delayed by an extra time interval 2060, with both regenerator pistons down and the space above them filled with heated air. At this time of maximum gas temperature and pressure, cam 1914 opens the upper valve to the hot air source, for example the air-circulating concentrating solar collector, exchanging fresh heat into the system. The valves then close, isolating the system from gas in the solar collector or other hot air source. Thus, the hot air source operates systematically at above-ambient pressure. When the lower four valves open in time region 2030, the system pressure is not far from ambient pressure and is restored to ambient pressure by the opening of the valves. The overall action is pump chilled air out the bottom of 1900 and warmed air out the middle.

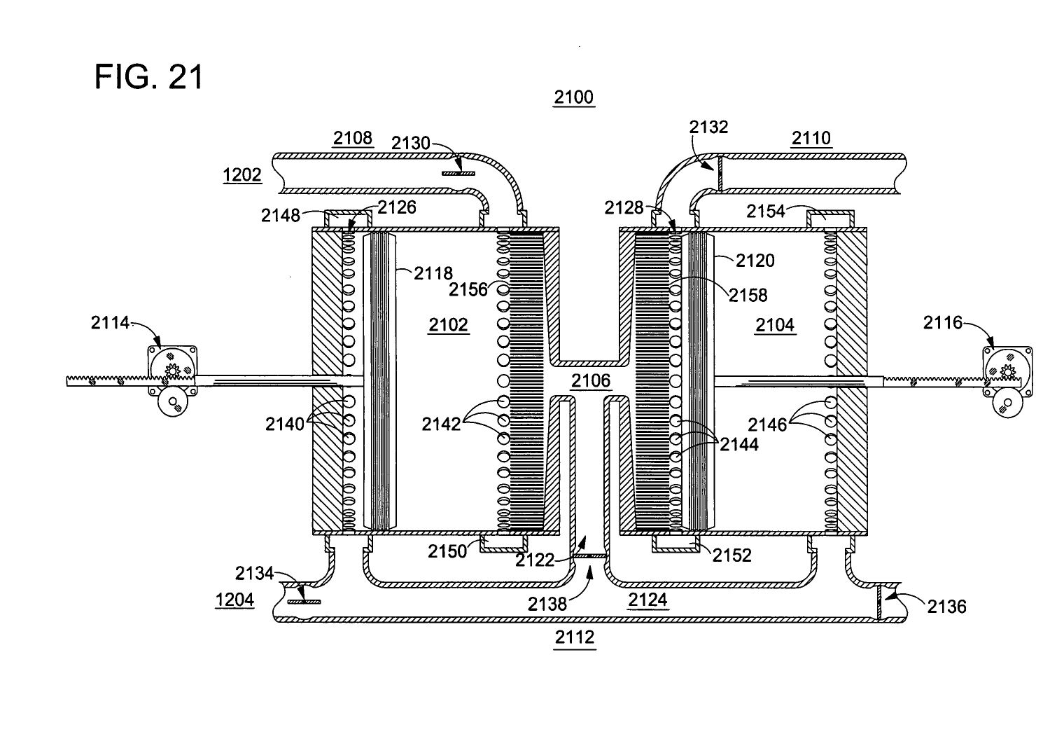

The system of FIG. 21 and drawing 2100 functions similarly to that of drawing 1900, excepting that this latter system employs two fixed regenerators and two separate moving displacer pistons. The regenerators are drawn like the others in diagrams here, as if they consisted of narrow honeycomb channels though a solid medium, while it is recognized that other approaches are viable, and many of them more economic, for instance including fused crossed wires for a mechanically robust moving regenerator piston, or a pebble bed for an economic and effective fixed regenerator. It will also be recognized that various actuation approaches apply, with the drawn rack-and-pinion approach being easy to implement but potentially not as long lasting as, for instance, a linear motor along the lines of 1510 or similar multiphase approaches. The purpose here is to provide relatively simple illustrations that bring out the underlying principles of the invention.

A potential advantage of the system embodiment of 21 is the flexibility gained by not requiring a moving regenerator. A displacer piston can be very lightweight, simplifying the linear actuation process. Also, less expensive options are available for fixed regenerators, particularly where weight is not an issue. As will be seen in following a description of 2100, a performance issue is dead volume. The dual regenerator pistons of 1700 and 1900 can move through overlapping ranges, exploiting all the available volume and thus enhancing performance. Working within given manageable high temperature limits, the system of 2100 cannot achieve as large an engine-mode pressure swing to drive the heat-pump-mode components. This limitation joins together with the lower “gamma” limitation of using diatomic air versus monatomic helium, along with related issues of the much higher molecular weight and molecular size of air molecules, compared to hydrogen or helium, these unalterable issues leading to much lower thermal conductivity. A dimensional analysis of regenerator function shows that combined efficiency and volume flow rate improve strongly with increasing regenerator area, while thickness is a minor issue, within limits and provided that appropriate finer materials are available for construction of thinner regenerators. With this consideration plus desire for a compact layout, the regenerators of 2100 are shown occupying the entire “floor space” of the working cylinders. This choice of shape was made independent of any consideration of a possible material. This layout also makes for a clear conceptual illustration, which will now be laid out verbally.

The detailed description of 2100 begins with naming and describing the essential components, by number, in functional categories. There are two mirror-image subassemblies, the cylindrical housings being joined by central bridging segment of pipe 2106. In addition to this center fluid interconnection, there are two gas input/output pipes, left and right at 2108 and 2110 across the top, and a single manifold pipe 2112 bridging across the bottom. The ends of 2112 terminate with servo valves, 2134 on the left and connecting into a high-temperature heater, for example connecting pipe 2104 of the concentrating solar collector drawn and referenced earlier. The opposite valve 2136 on the lower right connects to a gas source at an intermediate or warm temperature, for example from the cold air duct return of a home heating system. Near the left end, just inside valve 2134, the manifold pipe connects to the outside of a plenum consisting of a U-channel, circumferentially wrapped to capture an annular space that couples pneumatically into the left end of 2112. Holes 2140 punched through the walls of the cylinder allow gas to couple from the cylinder's left end into the annular plenum and connecting pipe. The mirror image of this structure is found on the right end of the cylinder with annular plenum 2154 coupled via holes 2146 to the interior end of the cylinder while the plenum connects on the outside to the right end of manifold pipe 2112, just inside valve 2136. The center of this manifold pipe couples via servo valve 2138 and radial connecting pipe 2122 into the bridging segment of pipe 2106, as previously described. The interior of this system is divided into four regions whose relative volumes vary due to the motion of displacer pistons. Hot and warm regions 2102 and 2126 are separated by moving regenerator 2118, driven by motor system 2114 and driving working fluid either through regenerator 2156 or between the internal system and external systems, depending on valve settings. Similarly warm and cold regions 2104 and 2128 are separated by moving regenerator 2120, driven by motor system 2116 and driving working fluid either through regenerator 2158 or between the internal system and external systems, again depending on valve settings.

The system of 2100 has five valves, among which two pairs are functionally joined to operate in the same way at the same time, whether by common electrical control of mechanical connection. Thus, hot air or other hot gas originating from 1202 and 1204, the numbered end components of the solar collector of drawing 1200, are controllably isolated from or connected to the variable-volume hot interior region 2102 by the simultaneous opening or closing of valves 2130 and 2134. Actuation of displacer piston 2118 by the motor and rack and pinion mechanism of 2114 causes volume 2102 to expand or contract under control. With valves 2130 and 2134 open and the remaining valves closed, as drawn, the piston action causes gas exhaust from cylinder region 2102 and complementary intake into cylinder region 2126 as the piston moves to the right, and the reverse as the piston moves left. Thus, slightly cooled hot air in 2102 can be almost totally exchanged for a fresh charge of hot air with a single stroke-right and stroke-left of 2118 driven by 2114. This action accomplishes the same kind of external heating gas exchange that takes place in time period 2060 of graph 2000, where in that case the gas exchange was mediate by blowers and gas flow through momentarily opened valves. System 2100 needs no blowers, although the continuations of passageways 1202 and 1204 toward the heating source might be brought together into a rectifying one-way check valve system that causes the air circulation at a more distant point, as in a solar collector tube, to always move in one direction.

When 1202 and 1204 close, then if valves 2132 and 2136 open as a pair, motion of regenerator piston 2120, powered via motor and rack and pinion mechanism 2116, can cause gas exchange between right-hand interior regions 2104 and 2128, with piston 2120 starting either toward the left as shown, or fully left, to maximize volume 2104, or with 2120 starting on the far right, to maximize volume 2128. Unlike the double-ended working fluid source of 1202 and 1204, optionally representing the connecting ends of a continuous solar collector tube, the fluid sources feeding into paired and commonly actuated valves 2132 and 2136 are not symmetric, being a cool or cold source feeding via 2132 into region 2128 (here almost minimized) and a warm source feeding via 2136 into region 2104 (here almost maximized). Because valves 2134 and 2136 share a common passageway 2124 and it is generally desired to lose high temperature heat via short-circuit to the warm fluid circuit, 2134 and 2136 are opened only during separate non-overlapping time periods. A back-and-forth stroke of piston 2120, driven by motor, rack and pinion mechanism 2116, therefore accomplishes an intake and exhaust stroke for one input, and in reverse order an exhaust and intake stroke for the other input, thereby exchanging heated warm air or chilled cool air with their respective sources. If there is a long connecting passageway for either or both of these air sources, it might be advantageous optionally to create a loop with one-way check valves to the right of valves 2132 and or 2136 to cause gas circulation from separated points and minimize re-breathing of gas.

Note that the three-way symmetry of passage 2108 on the upper right, 2110 on the upper left, and 2112 at the bottom center, suggest three rather than four external fluid connections might be feasible, with just one connecting line to hot source 1202, one to the warm gas, and one to the cool gas. This doesn't quite work, at least for the operating cycle to be described below, for reasons that are illuminating of the system function. To replenish hot air, it is desirable to open valves 2130 and 2134, expel the slightly cooled hot gas from the system, and draw fresh hot gas into a fully expanded region 2102, maximizing the quantity of hot gas on the hot left side of the regenerator when regenerator action resumes. However, when 2102 is full expanded, this represents the above-atmospheric (or above ambient for the warm and cool gases being used) condition of the heat pump, whose interior pressure should be brought back down to a near-match with the warm and cold inputs before those valves are opened. If the system has only three valves, assigned to hot, warm and cool gases then one cannot open the hot valve and the warm valve simultaneously for an exhaust-intake double stroke and still maintain pressure continuity with the closed-valve heat-pumping pressure cycle. Thus we see by counterexample that efficient operation calls for four valves, the left-hand pair connecting for circulation into and out of the hot gas source at high pressure, and for circulation into and out of the warm and cool gas sources at a lower pressure, for example atmospheric pressure. The hot volume 2102 is therefore maximized before opening valves 2130 and 2134, then the displacer piston moves right to displace gas out via 2130 and in via 2134, and finally the displacer moves back left to leave a maximum volume of hot gas in expanded region 2102. The system then cycles, with all valves closed, to a low pressure condition with piston 2118 shifted, hot volume 2102 minimized, and warm volume 2126 maximized. Refreshing the warm and cool or cold gases can start with displacer piston in any position, though a middle position may be desired for leaving equal refreshed half-volumes of warm and cold gas with each refresh stroke. Alternating between a full warm volume and a full cool or cold volume is feasible but entails worse pressure mismatches when valves are opened.

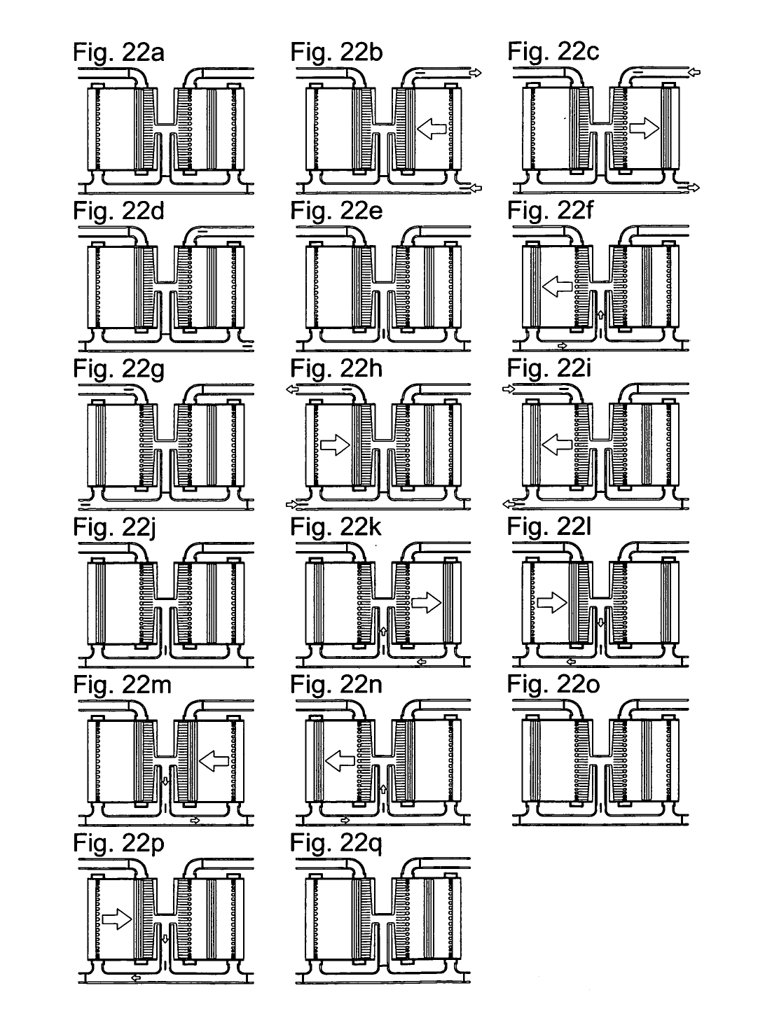

FIGS. 22a through 22q follow an example of the operational sequence of the system illustrated in FIG. 21. The rack and pinion mechanisms and piston shafts are omitted from the small simplified diagrams, which are intended only to illustrate the steps of an optional operation sequence. The following short paragraphs are labeled 22a through 22i and describe the illustrated steps of the corresponding figures.

22a The system starts at warm/cold ambient pressure, piston 2118 on the right, minimizing hot gas volume and pressure, with warm air filling the expanded space 2126, and with all valves closed. Piston 2120 is centered.

22b Valves 2132 and 2136 open and piston 2120 travels full left, expelling cold air and drawing in warm air.

22c Piston 2120 travels full-right, expelling warm air and drawing in cold air.

22d Piston 2120 returns to center, leaving half-volumes of refreshed warm and cold air.

22e Valves 2132 and 2136 close and valve 2138 opens to the channel 2122 leading to central passageway 2106 between the regenerators.

22f Piston 2156 moves full-left, heating gas via the regenerator and filling the hot volume, thus raising the pressure.

22g Valve 2138 closes, isolating the regenerators, and valves 2130 and 2134 open, exposing the hot side to the external heat source via 1202 and 1204.

22h Piston 2118 strokes right, momentarily filling expanded space 2126 with hot gas.

22i Piston 2118 strokes back left, re-filling volume 2102 with fresh hot gas.

22j Valves 2130 and 2134 close and regenerator valve 2138 opens. Air on the enclosed right side is now pressurized and at above-average temperature.

22k Piston 2120 strokes right, expanding cold volume 2128 and driving above-average-temperature warm air into the warmer left side of regenerator 2158, thus tending to heat that warm side.

22l Piston 2118 now strokes right, pushing hot air into the left side of regenerator 2156 while emerging warm air from the opposite side loops past open valve 2138 into filling region 2126 on the left of the piston. The system pressure is now low and the gas on the right side is cooled adiabatically.

22m Piston 2120 strokes left, pushing the cooled cold volume into the cold right side of regenerator 2158, thus further cooling that side of the regenerator, while warm air emerges from the other side of the regenerator and loops through valve 2138 into expanding region 2104.

22n Piston 2118 strokes left, raising pressures and temperatures. Observe that in the last few steps, pistons 2118 and 2120 have been moving in a quadrature sequence, one piston motion leading the other. It is this quadrature phasing of piston motions that pumps heat. This could be accomplished with continuous quadrature-phase sinusoidal motions, but non-overlapping full-stroke motions of the two pistons are more effective. This quadrature sequence could optionally continue for further cycles before the air exchange sequence to follow in this description and in the figures.

22o Piston 2120 returns to center position, pushing a half-stroke of compression-heated warm air into the left side of regenerator 2158.

22p Piston 2118 strokes right, cooling the system and lowering the pressure to near-ambient.

22q Center valve 2138 closes. All valves are now closed, and the system has returned to the state described with reference to FIG. 22a. This completes the cycle.

The above examples illustrate the core principles of the invention in differing contexts. It will be recognized that many other particular contexts and variations are possible, falling within the teaching provided in the above Specification and further by the following claims.

1. A heat-powered pneumatic compressor system for compressing a working fluid from a first pressure region to a second pressure region at higher pressure than the first, comprising:
a pressure containment component confining a volume of said working fluid in an interior region thereof;
a displacer, variably dividing said interior region of said pressure containment component into a hot region and a cold region such that volume increases in one region are accompanied by volume decreases in the other;
a regenerator, disposed between said hot region and said cold region and affecting a transient or oscillatory through-flow of said working fluid such that said working fluid flowing toward the hot region is heated and said working fluid flowing toward the cold region is cooled;
a heater arranged to add heat to said hot region; and
valve means, providing controllable pneumatic coupling between said interior region and a pneumatic load external to said interior region,
whereby flow of said working fluid via said valve means causes a systematic one-way flow of said working fluid to or from said external pneumatic load, delivering fluid power against a pressure differential in the pneumatic load.

2. System of claim 1 where the pneumatic load is a Rankine-cycle system including a Rankine working fluid for one-way heat transfer, where the Rankine working fluid and the compressor system working fluid are the same.

3. System of claim 1 where the pneumatic load is a superheated steam drying system with recycling of condensation heat and where steam from said drying system becomes the working fluid.

4. System of claim 1 where the pneumatic load is a liquid distillation system with recycling of condensation heat, and where vapor of said distillation system becomes the working fluid.

5. System of claim 1 where the pneumatic load is a system for concentration of solutions by solvent evaporation with recycling of condensation heat and where vapor from said solvent evaporation becomes the working fluid.

6. A heat-powered heat pump having a working fluid, comprising:
a pressure containment component, confining a volume of said working fluid in an interior region thereof, wherein the volume includes a first volume and a second volume;
a first displacer, variably subdividing said interior region of said pressure containment component into a hot region and a warm-cold region, such that first volume increases in one such region are accompanied by corresponding first volume decreases in another such region;
a second displacer, variably subdividing said warm-cold region into a warm region and a cold region, such that second volume increases in one such region are accompanied by corresponding second volume decreases in another such region;
a first regenerator, disposed between said hot region and said warm region and affecting a transient or oscillatory through-flow of the working fluid such that the working fluid flowing toward the hot region is heated and the working fluid flowing toward the warm region is cooled;
a second regenerator, disposed between said warm region and said cold region and affecting a transient or oscillatory through-flow of the working fluid such that the working fluid flowing toward the warm region is heated and the working fluid flowing toward the cold region is cooled;
a heater arranged to add heat to said hot region;
first valve means, providing controllable pneumatic coupling between said warm region and a first external region; and
second valve means, providing controllable pneumatic coupling between said warm cold region and a second external region,
whereby said valve means cause multiple periods of isolation of said interior region from said first and second external regions, said multiple periods alternating with periods of pneumatic connection between said interior region and said first and second external regions;

7. System of claim 6, wherein said first and second displacers cause said subdividing volume increases and decreases during said multiple periods of isolation.

8. System of claim 7, wherein said volume increases and decreases caused by said first displacer during isolation periods induces pressure variation in said cool and cold regions, wherein said second volume increases and second volume decreases caused by said second displacer cause systematic one-way heat flow, responsive to said pressure variation and to said second volume increases and decreases, results in unidirectional heat flow from said cold region to said warm region, lowering the temperature of said cold region.

9. System of claim 8, wherein said unidirectional heat flow from said cold region raises the temperature of said warm region, and heat flow from said hot region further raises the temperature of said warm region, and wherein the resulting net heat flow out of said cold region and into said warm region results in heating of said first external region and cooling of said second external region during said periods of pneumatic connection.

10. System of claim 6, further including third valve means, providing controllable pneumatic coupling between said heater and said hot region.

11. System of claim 10, whereby said controllable pneumatic coupling between said heater and said hot region provides coupling when interior region pressure is high, while said first and second valve means provide coupling when interior region pressure is low.

12. A heat engine having an operating cycle for the combined functions of pneumatic power production and waste heat removal via flow of a working fluid, comprising:
a pressure containment component, confining the volume of said working fluid in an interior region thereof;
a displacer, variably dividing said interior of said pressure containment into a hot region and a cold region, such that motion of said displacer causes volume changes in one of said regions and opposite volume changes in the other of said regions;
a regenerator, disposed between said hot region and said cold region, and affecting a transient or oscillatory through-flow of said working fluid such that working fluid flowing toward the hot region is heated in said regenerator and working fluid flowing toward the cold region is cooled in said regenerator;
a heater arranged to add heat to said hot region;
a valve, providing intermittent pneumatic coupling periods between one of said hot region and said cold region and a pneumatic load external to said interior region when said valve is open, and providing intermittent decoupling periods between said region and said load when said valve is closed;
wherein said displacer motion causes pressure change in said interior region during said decoupling periods and causes volume displacement with energy transfer during said coupling periods.

13. The heat engine of claim 12 wherein said energy transfer includes transfer of pneumatic energy as the product of pressure difference times volume displacement and further includes transfer of waste heat energy out of said heat engine.

14. The heat engine of claim 13 wherein said pneumatic energy transfer performs pneumatic output work on a coupled system.

15. The heat engine of claim 14 wherein said coupled system is a Rankine Cycle heat pump, wherein said pneumatic output work drives said heat pump, and wherein said heat pump operates with the same working fluid as said heat engine.

16. The heat engine of claim 14, wherein said coupled system is a Stirling-like vapor-phase heat pump, wherein said heat pump shares the same working fluid as said heat engine, and wherein said heat pump includes a second regenerator and a second displacer and operates said second displacer in coordination with said pneumatic energy transfer to transform said pneumatic energy into separate output streams of said working fluid, one of said streams being colder than a corresponding input stream of working fluid due to heat pumping into another one of said separate output streams.

17. A heat engine having an operating cycle for the combined functions of pneumatic power production and waste heat removal via flow of a working fluid, comprising:
a pressure containment component, intermittently confining the volume of said working fluid in an interior region thereof;
a regenerator, disposed between a hot region and a cooler region of said interior region, and affecting a transient or oscillatory through-flow of said working fluid such that said working fluid flowing toward the hot region is heated in said regenerator and said working fluid flowing toward the cooler region is cooled in said regenerator;
a displacer, variably dividing said interior of said pressure containment into said hot region and said cooler region, such that motion of said displacer causes volume changes in one of said regions and opposite volume changes in the other of said regions, thereby causing said transient or oscillatory through-flow in said regenerator;
a heater arranged to add heat to said hot region;
a valve, providing intermittent periods of coupling of said working fluid to a region external to said interior region when said valve is open, and providing intermittent periods of decoupling between said interior region and said external region when said valve is closed;
wherein said displacer motion causes pressure change in said interior region during said decoupling periods and causes volume displacement with energy transfer between said external and interior regions during said coupling periods,
wherein said energy transfer during said coupling periods includes the transfer of waste heat energy for said heat removal, and,
wherein said heat engine causes pneumatic energy transfer, as the product of pressure change and volume displacement, said energy transfer causing heat to be pumped against a temperature gradient.

18. The heat engine of claim 17, wherein said region external to said interior region includes a Rankine Cycle, wherein said pneumatic energy transfer drives said Rankine Cycle, and wherein said Rankine Cycle operates with the same working fluid as said heat engine.

19. The heat engine of claim 18, wherein said Rankine Cycle is a closed refrigerant cycle sharing the same working fluid as said heat engine, and wherein said Rankine cycle pumps heat by causing condensation of said working fluid at an elevated pressure in a condenser and evaporation of said working fluid at a lower pressure in an evaporator.

20. The heat engine of claim 18, wherein said Rankine Cycle is an open cycle for the evaporative removal of said working fluid from a material, wherein at least part of said working fluid removed from said material is compressed by said heat engine and caused to condense, whereby condensation heat promotes more of said evaporative removal.

21. The heat engine of claim 20, wherein said working fluid caused to condense is collected as a purified distillate.

22. The heat engine of claim 20, wherein said material is a liquid solution and wherein said evaporative removal from said material causes said solution to be concentrated.

23. The heat engine of claim 20, wherein said material is a solid material wetted by the liquid phase of said working fluid and wherein said evaporative removal from said material causes said material to be dried.

24. The heat engine of claim 17 further including a coupled Stirling-like vapor-phase heat pump, said heat pump being pneumatically coupled to said heat engine, said heat pump including a second regenerator and a second displacer, operated cyclically in coordination with operation of said heat engine, wherein said pneumatic energy from said heat engine causes compression and expansion of said working fluid in said heat pump, wherein said compression and expansion causes cyclic temperature change in said working fluid in said heat pump, and wherein said cyclic temperature change varies in-phase with volume displacement of said second displacer, thereby causing compression-heated working fluid to flow systematically into a first end of said second regenerator and expansion-cooled working fluid to flow systematically into an opposing second end of said second regenerator.

25. The heat engine of claim 24, wherein said compression-heated and expansion-cooled flows of said working fluid in said heat pump occur, at least in part, when said valve is closed to augment pressure change, wherein working fluid intermittently flows into said heat pump from part of said external region during at least some of said intermittent periods of coupling when said valve is open, and wherein cooled working fluid intermittently flows out of said heat pump into a different part of said external region during at least some of said intermittent periods of coupling when said valve is open, whereby heat is pumped from said working fluid that flows into said heat pump to produce said cooled working fluid that flows out of said heat pump.

26. The heat engine of claim 24, operated to cool a space.

27. The heat engine of claim 24, operated to heat a space with a combination of pumped heat and said waste heat from the operation of said heat engine and from energy losses in said heat pump.

28. A heat engine providing combined pneumatic power output and piston power output with convective cooling of an internal regenerator, comprising:
a pressure containment component, intermittently confining the volume of a working fluid in an interior region thereof;
a regenerator, disposed between a hot region and a cooler region of said interior region, and affecting a transient or oscillatory through-flow of said working fluid such that said working fluid flowing toward the hot region is heated in said regenerator and said working fluid flowing toward the cooler region is cooled in said regenerator;
a displacer, variably dividing said interior of said pressure containment into said hot region and said cooler region, such that motion of said displacer causes volume changes in one of said regions and opposite volume changes in the other of said regions, thereby causing said transient or oscillatory through-flow in said regenerator and further causing pressure variation, volume displacement, and output work through the heating and cooling action of said regenerator;
a heater arranged to add heat to said hot region;
one or more valves, providing intermittent periods of coupling of said working fluid to a region external to said interior region when said one or more of said one or more valves are open, and providing intermittent periods of decoupling between said region and said load when one or more of said one or more valves are closed;
a piston having two working areas, a first area operating between said interior region and said external region, and a larger second area functioning as said displacer within said interior region;
a motor/generator, coupled to said piston, initiating and powering the motion of said piston as needed, and receiving power from said piston to generate electricity under specific pneumatic loading conditions;
a pneumatic load, receiving pneumatic power via said one or more valves and causing said specific pneumatic loading conditions;
whereby coupling of working fluid flow to said pneumatic load via said valves causes convective cooling of said cooler region; and,
whereby said coupling causes said specific pneumatic loading conditions, which include a phase shift in said pressure variation relative to the displacement phase of said piston, thereby causing a shift from reactive pressure phase to power-generating pressure phase in the oscillatory pressure exerted on said first area of said piston, resulting in power generation.
